(19) United States
(12) Patent Application Publication
(10) Pub. No.: US 2004/0028806 A1
(43) Pub. Date: Feb. 12, 2004

(54) Process for producing electrolyte membrane-bonded electrode and varnish composition used therein

(76) Inventors: Makoto Higami, Tokyo (JP); Kohei Goto, Tokyo (JP); Nagayuki Kanaoka, Wako-shi (JP); Ryoichiro Takahashi, Wako-shi (JP); Yoichi Asano, Wako-shi (JP); Osamu Kakutani, Sayama-shi (JP); Gen Okiyama, Sayama-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/420,968

(22) Filed: Apr. 23, 2003

(30) Foreign Application Priority Data
Apr. 24, 2002 (JP) 2002-122822
Apr. 24, 2002 (JP) 2002-122823
Apr. 24, 2002 (JP) 2002-122824

(51) Int. Cl. B05D 5/12; B05D 3/02; B05D 1/36; B05D 1/02; C08K 3/00

(52) U.S. Cl. 427/58; 427/421; 427/385.5; 427/407.1; 524/544; 524/547

(57) ABSTRACT

The present invention is intended to provide A process for producing an electrolyte membrane-bonded electrode having excellent power generation properties property when constitutes in an electrode assembly, and a varnish composition for an electrolyte, by the use of which to obtain an electrolyte membrane-electrode bonded structure capable of retaining excellent power generation properties. is obtaned. A process for producing a first electrolyte membrane bonded electrode comprises applying, onto an electrode, a water containing dispersion containing a perfluorosulfonic acid polymer, an organic solvent A and water and having a perfluorosulfonic acid polymer content of 0.5 to 20% by weight and then applying, onto the resulting film, a solution of sulfonated polyarylene in an organic solvent B, to form an electrolyte comprises applying, onto an electrode, a solution or dispersion containing a proton conductive polymer, an organic solvent B and water and having a water content of 25 to 50% by wegiht and then applying, onto the resulting film, a solution or dispersion containing a proton conductive polymer, an organic solvent B and water and having a water content of less than 25% by weight, to form an electrolyte membrane. A process for producing a third electrolyte membrane bonded electrode comprises applying, onto an electrode, a varnish composition 6 obtained by dissolving a sulfonated polymer in a solvent containing an organic solvent C, an organic solvert D and water to form an electrolyte membrane, said organic solvent C being a good solvent for the sulfonated polymer and having a higher boiling point than that of other solvent components, said organic solvent D having a boiling point of not lower than 50° C. and being not a good solvent for the sulfonated polymer when used alone but causing a solubility region of the sulfonated polymer to appear when mixed with the organic solvent C and/or the water. The varnish composition 6 of the invention is a varnish composition obtained by dissolving the sulfonated polymer in a solvent containing an organic solvent C, an organic solvent D and water.

### FIELD OF THE INVENTION

The present invention relates to a process for producing an electrolyte membrane-bonded electrode which is favorable for a fuel cell.

The present invention also relates to a varnish composition for an electrolyte, by the use of which an electrolyte membrane-bonded electrode capable of retaining excellent power generation property is obtained, and an electrolyte membrane-bonded electrode using the varnish composition.

### BACKGROUND OF THE INVENTION

A fuel cell is usually formed as a unit from an electrode and an electrolyte membrane (proton-conductive membrane).

The electrode and the electrolyte membrane have heretofore been formed as a unit in the following manner. A catalyst paste is previously prepared from an electrolyte solution and a hydrogen reduction catalyst supported on carbon. The catalyst paste is applied onto a carbon paper and heat treated to form an electrode layer. Then, a filmy electrolyte membrane is sandwiched between two electrode layers and molded by a hot press to perform triple-layer bonding of anode/electrolyte membrane/cathode, whereby a membrane/electrode assembly (MEA) is produced.

Such a three-layer bonding method as mentioned above, however, has technical problems, such as bond properties of the layers are poor, uniting of three layers takes a long time, and this method is unsuitable for mass production because the layers are formed individually.

Further, the electrolyte membrane of high heat resistance, for which a demand has grown recently, has a problem that its thermoplasticity is so insufficient that some restrictions apply in molding by a hot press.

Therefore, there has been proposed a process comprising forming an electrode, then applying, onto the electrode, a varnish obtained by dissolving a substance for forming an electrolyte layer in a solvent, drying the varnish on the electrode to produce an electrolyte membrane-bonded electrode, and bonding two of the electrolyte membrane-electrode bonded structures in such a manner that the electrolyte membranes face each other to produce a membrane/electrode assembly.

The above process, however, has a problem that the varnish in which the electrolyte having high heat resistance is dissolved is repelled by the electrode and cannot be applied, or even if the varnish can be applied, the electrolyte membrane component penetrates into the electrode layer excessively, and hence the power generation property of the resulting membrane-electrode assembly is insufficient.

### OBJECT OF THE INVENTION

It is an object of the present invention to provide a process for producing an electrolyte membrane-bonded electrode, by which an electrolyte membrane-electrode bonded structure exhibiting excellent power generation property when constitutes an electrode assembly can be obtained.

It is another object of the invention to provide a process for producing an electrolyte membrane-bonded electrode, by which an electrolyte layer can be formed on an electrode layer without penetration of the electrolyte into the electrode, and an electrolyte membrane-electrode bonded structure exhibiting excellent power generation property when constitutes an electrode assembly can be obtained.

It is a further object of the invention to provide a varnish composition for an electrolyte, which can be applied onto an electrode without being repelled and by the use of which an electrolyte membrane-electrode assembly exhibiting excellent power generation property can be obtained, and to provide a process for producing an electrolyte membrane-bonded electrode using the varnish composition.

### DISCLOSURE OF THE INVENTION

According to the present invention, the following process for producing an electrolyte membrane-bonded electrode and the following varnish composition are provided, and thereby the objects of the present invention can be attained.

(1) A process for producing an electrolyte membrane-bonded electrode, comprising:

applying, onto an electrode, a water-containing dispersion which is obtained by dispersing a perfluorosulfonic acid polymer in a solvent containing an organic solvent A and water and has a perfluorosulfonic acid polymer content of 0.5 to 20% by weight, drying the dispersion to form a thin film 1 comprising the perfluorosulfonic acid polymer, then applying, onto the thin film 1, a solution of sulfonated polyarylene in an organic solvent B, and drying the solution to form a thin film 2 comprising the sulfonated polyarylene; and

thereby forming an electrolyte membrane comprising the thin film 1 and the thin film 2.

(2) The process for producing an electrolyte membrane-bonded electrode as stated in the above (1), wherein the water-containing dispersion of the perfluorosulfonic acid polymer is applied onto the electrode by spray coating.

(3) A process for producing an electrolyte membrane-bonded electrode, comprising:

applying, onto an electrode, a proton-conductive polymer solution or dispersion which is obtained by dissolving or dispersing a proton-conductive polymer in a solvent containing an organic solvent B and water and has a water content of 25 to 50% by weight, drying the solution or dispersion to form a thin film 3 comprising the proton-conductive polymer, then applying, onto the thin film 3, a proton-conductive polymer solution or dispersion which is obtained by dissolving or dispersing a proton-conductive polymer in a solvent containing an organic solvent B and water and has a water content of less than 25% by weight, and drying the solution or dispersion to form a thin film 4 comprising the proton-conductive polymer; and

thereby forming an electrolyte membrane comprising the thin film 3 and the thin film 4.

(4) The process for producing an electrolyte membrane-bonded electrode as stated in the above (3), wherein the proton-conductive polymer is sulfonated polyarylene.

(5) A process for producing an electrolyte membrane-bonded electrode, comprising:

applying, onto an electrode, a varnish composition 6 obtained by dissolving a sulfonated polymer in a solvent containing an organic solvent C, an organic solvent D and water, said organic solvent C being a good solvent for the sulfonated polymer and having a higher boiling point than that of other solvent components, said organic solvent D having a boiling point of not lower than 50° C. and being not a good solvent for the sulfonated polymer when used alone but causing a solubility region of the sulfonated polymer to appear when mixed with the organic solvent C and/or the water, and

drying the varnish composition 6 to form an electrolyte membrane comprising the sulfonated polymer.

(6) The process for producing an electrolyte membrane-bonded electrode as stated in the above (5), wherein the organic solvent C is a non-protonic dipole solvent having a dielectric constant of not less than 20.

(7) The process for producing an electrolyte membrane-bonded electrode as stated in the above (5), wherein the organic solvent D is selected from an alcohol, an ether and a ketone and has a solubility parameter of 7 to 14.5 (cal/mol)^{1/2}.

(8) The process for producing an electrolyte membrane-bonded electrode as stated in the above (5), wherein the organic solvent D is at least one solvent selected from ethanol, 1-propanol, 2-propanol, tetrahydrofuran, 1,3-dioxolan, dimethoxyethane, acetone, methyl ethyl ketone and cyclohexanone.

(9) The process for producing an electrolyte membrane-bonded electrode as stated in the above (5), wherein the weight ratio among the organic solvent C, the organic solvent D and water used is in the range of 20-85:10-75:5-70, with the proviso that the total is 100.

(10) The process for producing an electrolyte membrane-bonded electrode as stated in the above (5), wherein the sulfonated polymer is a non-perfluorohydrocarbonic sulfonated polymer or a sulfonated polymer having a polyarylene structure in its main chain.

(11) A process for producing an electrolyte membrane-bonded electrode, comprising:

applying, onto an electrode, a varnish composition 6 obtained by dissolving a sulfonated polymer in a solvent containing an organic solvent C, an organic solvent D and water, said organic solvent C being a good solvent for the sulfonated polymer and having a higher boiling point than that of other solvent components, said organic solvent D having a boiling point of not lower than 50° C. and being not a good solvent for the sulfonated polymer when used alone but causing a solubility region of the sulfonated polymer to appear when mixed with the organic solvent C and/or the water,

drying the varnish composition 6 to form a thin film 6 comprising the sulfonated polymer,

then applying, onto the thin film 6, a varnish composition 7 obtained by dissolving a sulfonated polymer in a solvent consisting essentially of an alcohol having a boiling point of not higher than 100° C. and an organic solvent E having a boiling point of higher than 100° C., and drying the varnish composition 7 to form a thin film 7;

and thereby forming an electrolyte membrane comprising the thin film 6 and thin film 7.

(12) The process for producing an electrolyte membrane-bonded electrode as stated in the above (11), wherein the alcohol for constituting the varnish composition 7 is methanol, ethanol, propanol or isopropyl alcohol.

(13) The process for producing an electrolyte membrane-bonded electrode as stated in the above (11), wherein the organic solvent E for constituting the varnish composition 7 is at least one solvent selected from N-methyl-2-pyrrolidone, N,N-dimethylformamide, N,N-dimethylacetamide, γ-butyrolactone, tetramethylurea, dimethyl sulfoxide, hexamethylphosphoric amide and sulfolane.

(14) The process for producing an electrolyte membrane-bonded electrode as stated in the above (11), wherein the weight ratio between the alcohol and the organic solvent E used for constituting the varnish composition 7 is in the range of 5-75:95-25, with the proviso that the total is 100.

(15) A varnish composition obtained by dissolving a sulfonated polymer in a solvent containing an organic solvent C, an organic solvent D and water, wherein:

the organic solvent C is a good solvent for the sulfonated polymer and has a higher boiling point than that of other solvent components, and

the organic solvent D has a boiling point of not lower than 50° C. and is not a good solvent for the sulfonated polymer when used alone but causes a solubility region of the sulfonated polymer to appear when mixed with the organic solvent C and/or the water.

(16) The varnish composition as stated in the above (15), wherein the organic solvent C is a non-protonic dipole solvent having a dielectric constant of not less than 20.

(17) The varnish composition as stated in the above (15), wherein the organic solvent D is selected from an alcohol, an ether, and a ketone and has a solubility parameter of 7 to 14.5 (cal/mol)^{1/2},

(18) The varnish composition as stated in the above (15), wherein the organic solvent D is at least one solvent selected from ethanol, 1-propanol, 2-propanol, tetrahydrofuran, 1,3-dioxolan, dimethoxyethane, acetone, methyl ethyl ketone and cyclohexanone.

(19) The varnish composition as stated in the above (15), wherein the weight ratio among the organic solvent C, the organic solvent D and water used is in the range of 20-85:10-75:5-70, with the proviso that the total is 100.

(20) The varnish composition as stated in the above (15), wherein the sulfonated polymer is a non-perfluorohydrocarbonic sulfonated polymer or a sulfonated polymer having a polyarylene structure in its main chain.

(21) The varnish composition as stated in the above (15), which is a varnish composition for forming a proton-conductive membrane.

### PREFERRED EMBODIMENTS OF THE INVENTION

The present invention is described in detail hereinafter.

<Process for Producing First Electrolyte Membrane-Bonded Electrode>

In a process for producing a first electrolyte membrane-bonded electrode according to the invention, a water-containing dispersion obtained by dispersing a perfluorosulfonic acid polymer in a solvent containing an organic solvent A and water and a solution of sulfonated polyarylene in an organic solvent B are applied onto an electrode to form a thin film 1 and a thin film 2, and thereby an electrolyte membrane layer comprising the thin film 1 and the thin film 2 is formed, whereby an electrolyte membrane-bonded electrode is produced.

<Electrode>

The electrode for use in the invention is prepared by, for example, applying, onto a gas-diffusion electrode substrate, a paste comprising catalyst fine particles having hydrogen reduction ability, which are supported on conductive porous particles, and a proton-conductive high-molecular weight electrolyte component (e.g., Nafion (trade name) available from DuPont Co.).

As the conductive porous particles, those having high structure and large surface area, such as Ketjen black and acetylene black, are employed.

Examples of the catalysts having hydrogen reduction ability include noble metals, such as platinum, palladium, ruthenium and rhodium, and alloys of these metals and other metals such as chromium, molybdenum, tungsten, titanium, zirconium and cobalt. The amount of the catalyst supported is in the range of usually 10 to 60% by weight based on the conductive porous particles.

The electrode is prepared by applying the paste onto a porous gas diffusion electrode substrate, such as a carbon paper or a carbon cloth, by means of a doctor blade or a spray. A commercially available electrode sheet with a carbon paper is also employable.

The thickness of the electrode is in the range of usually 5 to 100 μm, preferably 5 to 50 μm.

<Thin Film 1 (Perfluorosulfonic Acid Polymer Layer)>

In the present invention, the thin film 1 (perfluorosulfonic acid polymer layer) is formed from the following perfluorosulfonic acid polymer.

The perfluorosulfonic acid polymer employable for the first electrolyte membrane-bonded electrode is, for example, a tetrafluoroethylene copolymer represented by the following formula (1):

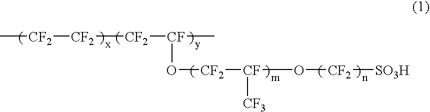

wherein x is a number of 1 to 30, y is a number of 10 to 2,000, m is a number of 0 to 10, and n is a number of 1 to 10.

The tetrafluoroethylene copolymer is, for example, a sulfonated polymer having a sulfonic acid group which is obtained by hydrolyzing a copolymer of tetrafluoroethylene and perfluorovinyl ether having a sulfonylfluoride group at the terminal, or a carboxylated polymer wherein a part of or all of the sulfonic acid groups are replaced with carboxyl groups.

The thickness of the perfluorosulfonic acid polymer layer (thin film 1) obtained from the perfluorosulfonic acid polymer is in the range of usually 0.1 to 10 μm, preferably 0.3 to 8 μm.

<Thin Film 2 (Sulfonated Polyarylene Layer)>

In the present invention, the thin film 2 (sulfonated polyarylene layer) is formed from the following sulfonated polyarylene.

The sulfonated polyarylene is, for example, one obtained by sulfonating polyarylene that is obtained by reacting a monomer (A) represented by the following formula (A) with at least one monomer (B) selected from the following monomers (B-1) to (B-4).

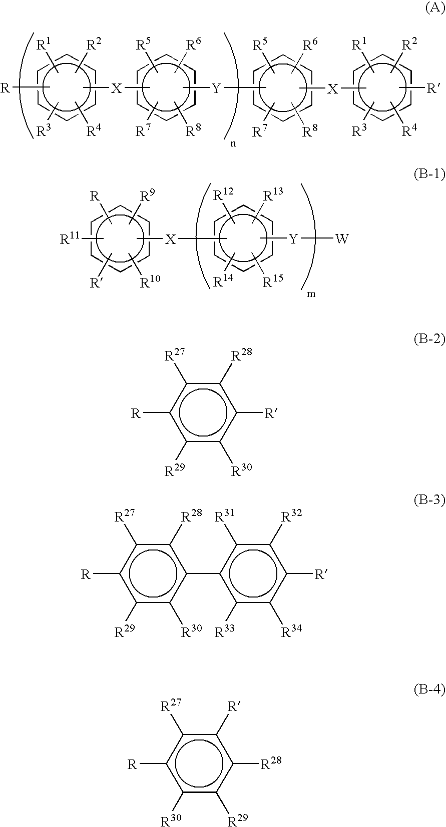

In the formula (A), R and R′ may be the same or different and are each a halogen atom other than a fluorine atom or a group represented by —OSO₂Z (Z is an alkyl group, a fluorine-substituted alkyl group or an aryl group).

Examples of the alkyl groups indicated by Z include methyl and ethyl. Examples of the fluorine-substituted alkyl groups include trifluoromethyl. Examples of the aryl groups include phenyl and p-tolyl.

R¹ to R⁸ may be the same or different and are each at least one atom or group selected from the group consisting of a hydrogen atom, a fluorine atom, an alkyl group, a fluorine-substituted alkyl group, an allyl group and an aryl group.

Examples of the alkyl groups include methyl, ethyl, propyl, butyl, amyl and hexyl. Of these, preferable are methyl, ethyl and the like.

Examples of the fluorine-substituted alkyl groups include trifluoromethyl, perfluoroethyl, perfluoropropyl, perfluorobutyl, perfluoropentyl and perfluorohexyl. Of these, preferable are trifluoromethyl, pentalfuoroethyl and the like.

Examples of the allyl groups include propenyl.

Examples of the aryl groups include phenyl and pentafluorophenyl.

X is a divalent electron attractive group. Examples of the electron attractive groups include —CO—, —CONH—, —(CF₂)ₚ— (p is an integer of 1 to 10), —C(CF₃)₂—, —COO—, —SO— and —SO₂—.

The electron attractive group means a group having a Hammett substituent constant of not less than 0.06 in case of the m-position of a phenyl group and not less than 0.01 in case of the p-position thereof.

Y is a divalent electron donative group. Examples of the electron donative groups include —O—, —S—, —CH═CH—, C≡C— and groups represented by the following formulas.

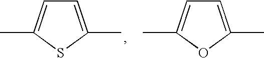

n is 0 or a positive integer, and its upper limit is usually 100, preferably 80.

Examples of the monomers represented by the formula (A) include 4,4′-dichlorobenzophenone, 4,4′-dichlorobenzanilide, bis(chlorophenyl)difluoromethane, 2,2-bis(4-chlorophenyl)hexafluoropropane, 4-chlorobenzoic acid-4-chlorophenyl, bis(4-chlorophenyl)sulfoxide, bis(4-chlorophenyl)sulfone, compounds corresponding to the above compounds in which the chlorine atom is replaced with a bromine atom or an iodine atom, and compounds corresponding to the above compounds in which the halogen atom substituted at the 4-position is substituted at the 3-position.

As other examples of the monomers represented by the formula (A), there can be mentioned 4,4′-bis(4-chlorobenzoyl)diphenyl ether, 4,4′-bis(4-chlorobenzoylamino)diphenyl ether, 4,4′-bis(4-chlorophenylsulfonyl)diphenyl ether, 4,4′-bis(4-chlorophenyl)diphenyl ether dicarboxylate, 4,4′-bis[(4-chlorophenyl)-1,1,1,3,3,3-hexafluoropropyl]diphenyl ether, 4,4′-bis[(4-chlorophenyl)tetrafluoroethyl]diphenyl ether, compounds corresponding to the above compounds in which the chlorine atom is replaced with a bromine atom or an iodine atom, compounds corresponding to the above compounds in which the halogen atom substituted at the 4-position is substituted at the 3-position, and compounds corresponding to the above compounds in which at least one of groups substituted at the 4-position of diphenylether is substituted at the 3-position.

As other examples of the monomers represented by the formula (A), there can be further mentioned 2,2-bis[4-{4-(4-chlorobenzoyl)phenoxy}phenyl]-1,1,1,3,3,3-hexafluoropropane, bis[4-{4-(4-chlorobenzoyl)phenoxy}phenyl]sulfone, and compounds represented by the following formulas.

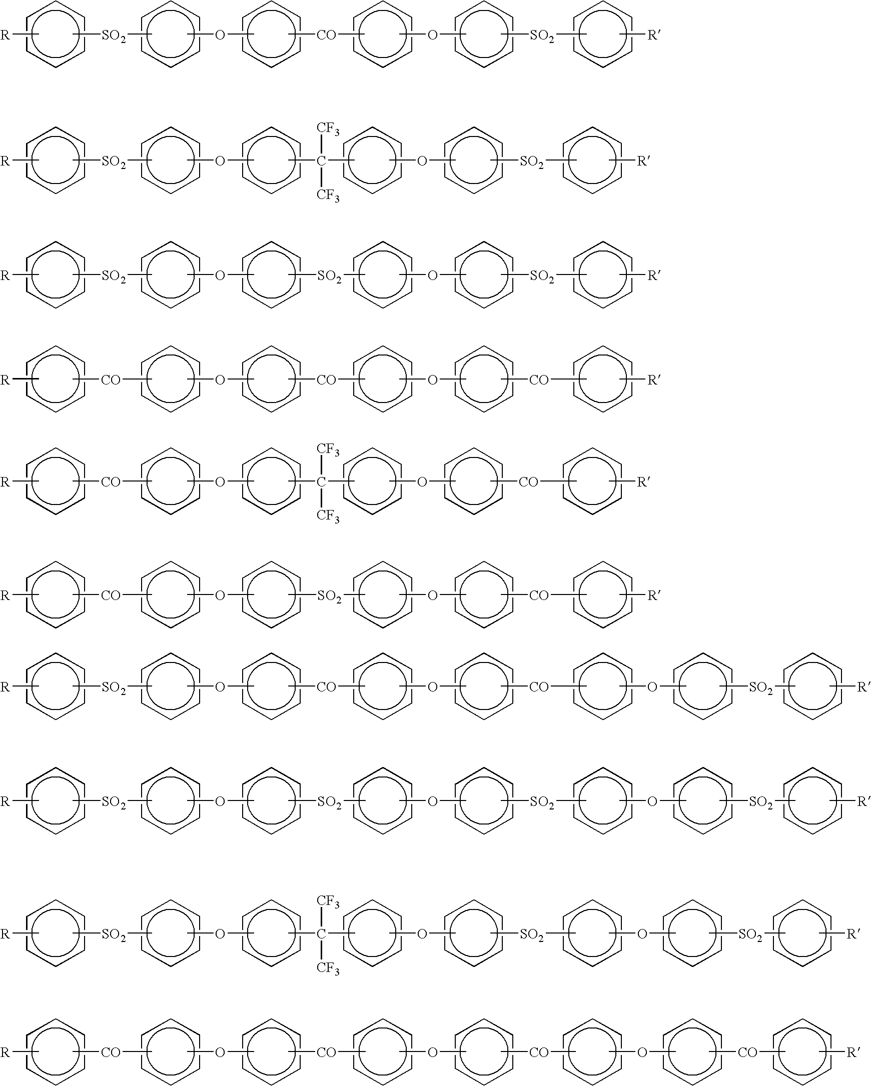

The monomer represented by the formula (A) can be synthesized by, for example, the following process.

In order to convert bisphenols connected with an electron attractive group into the corresponding alkali metal salt of bisphenol, the bisphenols are reacted with an alkali metal, such as lithium, sodium or potassium, or an alkali metal compound, such as an alkali metal hydride, an alkali metal hydroxide or an alkali metal carbonate, in a polar solvent having a high dielectric constant, such as N-methyl-2-pyrrolidone, N,N-dimethylacetamide, sulfolane, diphenylsulfone or dimethyl sulfoxide. The alkali metal or the like is usually reacted in slight excess amount based on the amount of the hydroxyl groups of the bisphenol, and is used in an amount of usually 1.1 to 2.0 times by equivalent, preferably 1.2 to 1.5 times by equivalent.

In this case, an aromatic dihalide compound having been activated by the electron attractive group, such as 4,4′-difluorobenzophenone, 4,4′-dichlorobenzophenone, 4,4′-chlorofluorobenzophenone, bis(4-chlorophenyl)sulfone, bis(4-fluorophenyl)sulfone, 4-fluorophenyl-4′-chlorophenylsulfone, bis(3-nitro-4-chlorophenyl)sulfone, 2,6-dichlorobenzonitrile, 2,6-difluorobenzonitrile, hexafluorobenzene, decafluorobiphenyl, 2,5-difluorobenzophenone or 1,3-bis(4-chlorobenzoyl)benzene, is reacted in the presence of a solvent azeotropic with water, such as benzene, toluene, xylene, hexane, cyclohexane, octane, chlorobenzene, dioxane, tetrahydrofuran, anisole or phenetole. From the viewpoint of reactivity, the aromatic dihalide compound is preferably a fluorine compound, but taking the subsequent aromatic coupling reaction into account, it is necessary to construct the aromatic nucleophilic displacement reaction in such a manner that a terminal of the molecule should be a chlorine atom. The active aromatic dihalide compound is used in an amount of 2 to 4 times by mol, preferably 2.2 to 2.8 times by mol, as much as the bisphenol. Prior to the aromatic nucleophilic displacement reaction, an alkali metal salt of bisphenol may be prepared. The reaction temperature is in the range of 60 to 300° C., preferably 80 to 250° C. The reaction time is in the range of 15 minutes to 100 hours, preferably 1 hour to 24 hours. As indicated by the following formula, it is most preferable to use, as the active aromatic dihalide, a chlorofluoro compound having one chlorine atom and one fluorine atom which are different in the reactivity, whereby the fluorine atom preferentially undergoes nucleophilic displacement reaction with phenoxide, so that this is advantageous in obtaining the desired chloroterminated compound having been activated.

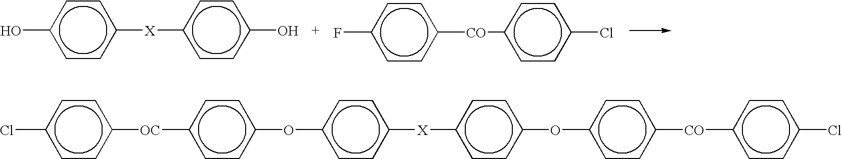

wherein X and Y have the same meanings as defined above with regard to the formula (A).

In another process for synthesizing the monomer represented by the formula (A), the nucleophilic displacement reaction is combined with an electrophilic substitution reaction to synthesize the desired flexible compound comprising an electron attractive group and an electron donative group, as described in Japanese Patent Laid-Open Publication No. 159/1990.

More specifically, the aromatic dihalide having been activated by the electron attractive group, such as bis(4-chlorophenyl)sulfone, is subjected to nucleophilic displacement reaction with a phenol compound to prepare a bisphenoxy compound. Then, this substituted compound is subjected to Friedel-Crafts reaction with 4-chlorobenzoyl chloride to obtain the desired compound.

The above-exemplified compounds are applicable to the aromatic dihalide having been activated by the electron attractive group used herein. The phenol compound may be substituted, but from the viewpoints of heat resistance and flexibility, an unsubstituted phenol compound is preferable. When the phenol compound is substituted, this compound is preferably an alkali metal salt, and as the alkali metal compound for use in the substitution of the phenol compound, the above-exemplified compound is employable. The alkali metal compound is used in an amount of 1.2 to 2 times by mol as much as 1 mol of the phenol. In the reaction, the aforesaid polar solvent or azeotropic solvent with water is employable.

For obtaining the desired compound, the bisphenoxy compound is reacted with chlorobenzoyl chloride, which is an acylating agent, in the presence of an activator for the Friedel-Crafts reaction, e.g., Lewis acid such as aluminum chloride, boron trifluoride or zinc chloride. The chlorobenzoyl chloride is used in an amount of 2 to 4 times by mol, preferably 2.2 to 3 times by mol, as much as the bisphenoxy compound. The Friedel-Crafts activator is used in an amount of 1.1 to 2 times by equivalent as much as 1 mol of the active halide compound such as chlorobenzoic acid that is an acylating agent. The reaction time is in the range of 15 minutes to 10 hours, and the reaction temperature is in the range of −20 to 80° C. As a solvent, chlorobenzene, nitrobenzene or the like that is inactive to the Friedel-crafts reaction is employable.

The monomer (A) represented by the formula (A) wherein n is not less than 2 can be obtained as follows. For example, a compound obtained by combining bisphenol, which is a supply source of ethereal oxygen that is an electron donative group Y in the formula (A), with >C—O, —SO₂— and/or >C(CF₃)₂, which is an electron attractive group X, specifically, an alkali metal salt of bisphenol, such as 2,2-bis(4-hydroxyphenyl)-1,1,1,3,3,3-hexafluoropropane, 2,2-bis(4-hydroxyphenyl)ketone or 2,2-bis(4-hydroxyphenyl)sulfone, is subjected to displacement reaction with an excess of an active aromatic halogen compound, such as 4,4-dichlorobenzophenone or bis(4-chlorophenyl)sulfone, in the presence of a polar solvent, such as N-methyl-2-pyrrolidone, N,N-dimethylacetamide or sulfolane, in accordance with the aforesaid synthesis of the monomer.

Examples of such monomers (A) include compounds represented by the following formulas.

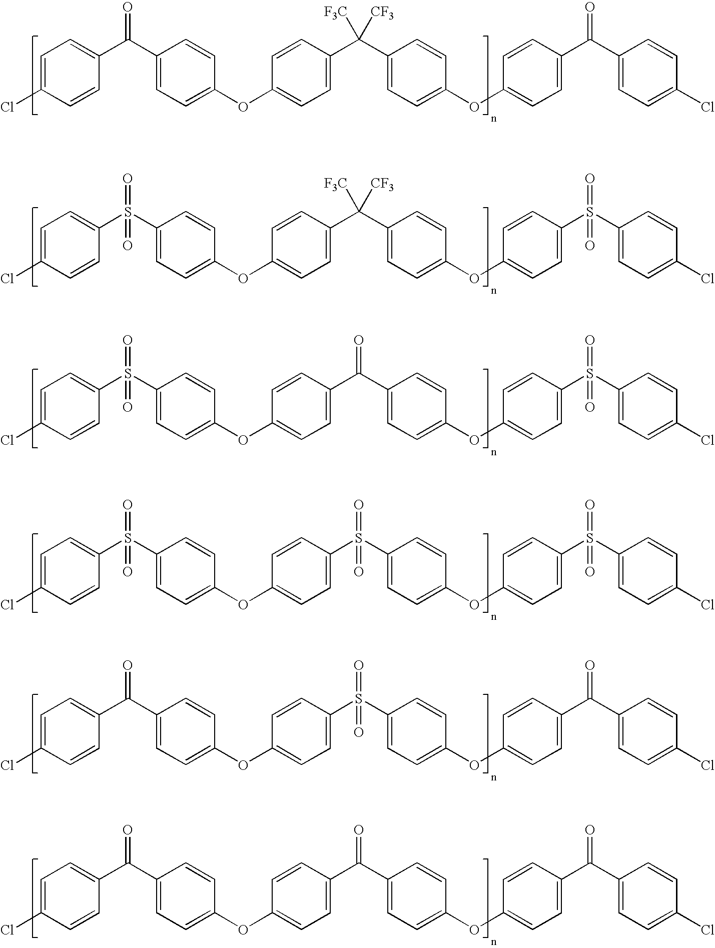

In the above formulas, n is not less than 2, preferably 2 to 100.

Next, the monomers represented by the formula (B-1) to (B-4) are described.

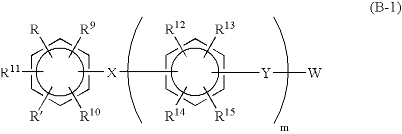

In the above formula, R and R′ may be the same or different and are the same groups as R and R′ in the formula (A).

R⁹ to R¹⁵ may be the same or different and are each at least one atom or group selected from a hydrogen atom, a fluorine atom and an alkyl group.

Examples of the alkyl groups indicated by R⁹ to R¹⁵ include the same alkyl groups as indicated by R¹ to R⁸ in the formula (A).

m is 0, 1 or 2.

X is a divalent electron attractive group selected from the same group as shown for X in the formula (A).

Y is a divalent electron donative group selected from the same group as shown for Y in the formula (A).

W is at least one group selected from the group consisting of a phenyl group, a naphthyl group and groups represented by the following formulas (C-1) to (C-3).

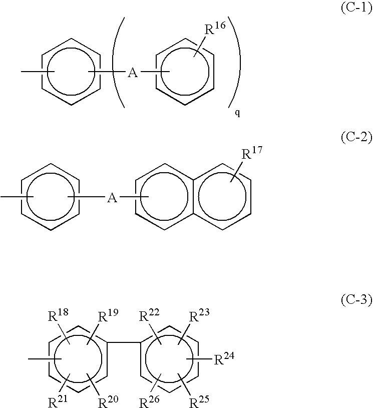

In the above formulas, A is an electron donative group or a single bond.

The electron donative group is a divalent electron donative group selected from the same group as shown for Y in the formula (A).

R¹⁶ and R¹⁷ are each an atom or a group selected from the group consisting of a hydrogen atom, an alkyl group and an aryl group.

Examples of the alkyl groups and the aryl groups indicated by R¹⁶ and R¹⁷ include the same alkyl groups and the same aryl groups as indicated by R¹ to R⁸ in the formula (A).

R¹⁸ to R²⁶ may be the same or different and are each at least one atom or group selected from a hydrogen atom, a fluorine atom and an alkyl group.

q is 0 or 1.

Examples of the monomers represented by the formula (B-1) include compounds represented by the following formulas.

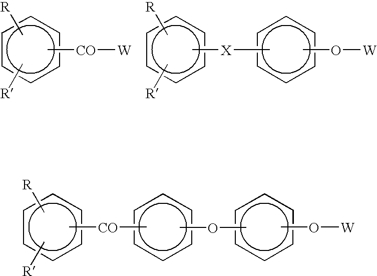

More specifically, there can be mentioned compounds represented by the following formulas as the compounds represented by the formula (B-1).

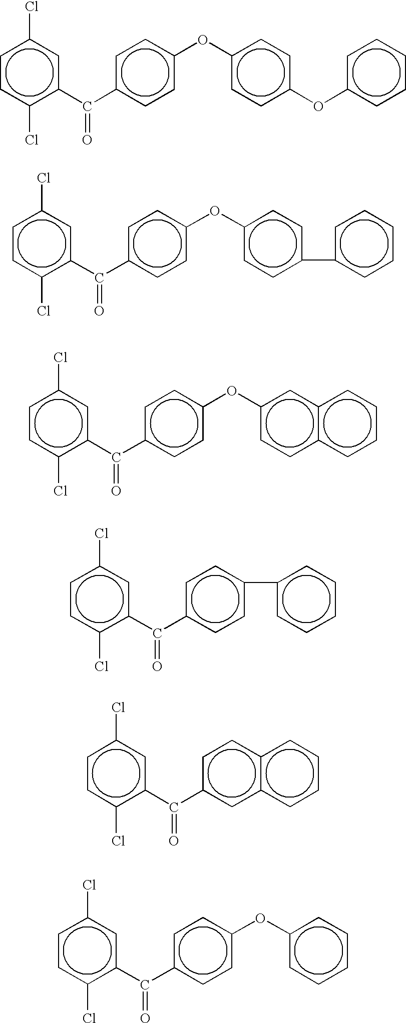

Further, compounds corresponding to the above compounds in which the chlorine atom is replaced with a bromine atom or an iodine atom are also available.

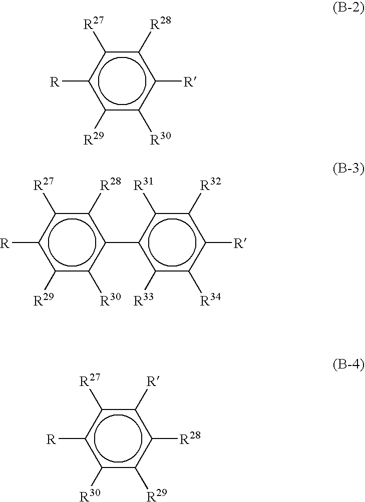

In the formulas (B-2), (B-3) and (B-4), R and R′ may be the same or different and are the same groups as R and R′ in the formula (A).

R²⁷ to R³⁴ may be the same or different and are each a hydrogen atom, a fluorine atom, an alkyl group, a fluorine-substituted alkyl group, an aryl group or a group represented by the following formula (D).

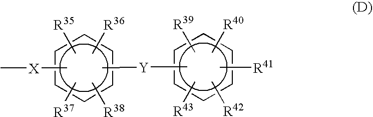

In the formula (D), R³⁵ to R⁴³ may be the same or different and are each a hydrogen atom, a halogen atom, an alkyl group or a fluorine-substituted alkyl group.

Examples of the alkyl groups and the fluorine-substituted alkyl groups indicated by R²⁷ to R³⁴ and R³⁵ to R⁴³ include the same alkyl groups and the same fluorine-substituted alkyl groups as indicated by R¹ to R⁸. Examples of the aryl groups indicated by R²⁷ to R³⁴ include the same aryl groups as indicated by R¹ to R⁸.

X is a divalent electron attractive group selected from the same group as shown for X in the formula (A).

Y is a divalent electron donative group selected from the same group as shown for Y in the formula (A).

Examples of the monomers represented by the formula (B-2) include p-dichlorobenzene, p-dimethylsulfonyloxybenzene, 2,5-dichlorotoluene, 2,5-dimethylsulfonyloxybenzene, 2,5-dichloro-p-xylene, 2,5-dichlorobenzotrifluoride, 1,4-dichloro-2,3,5,6-tetrafluorobenzene, and compounds corresponding to the above compounds in which the chlorine atom is replaced with a bromine atom or an iodine atom.

Examples of the monomers represented by the formula (B-3) include 4,4′-dimethylsulfonyloxybiphenyl, 4,4′-dimethylsulfonyloxy-3,3′-dipropenylbiphenyl, 4,4′-dibromobiphenyl, 4,4′-diiodobiphenyl, 4,4′-dimethylsulfonyloxy-3,3′-dimethylbiphenyl, 4,4′-dimethylsulfonyloxy-3,3′-difluorobiphenyl, 4,4′-dimethylsulfonyloxy-3,3′,5,5′-tetrafluorobiphenyl, 4,4′-dibromooctafluorobiphenyl and 4,4′-dimethylsulfonyloxyoctafluorobiphenyl.

Examples of the monomers represented by the formula (B-4) include m-dichlorobenzene, m-dimethylsulfonyloxybenzene, 2,4-dichlorotoluene, 3,5-dichlorotoluene, 2,6-dichlorotoluene, 3,5-dimethylsulfonyloxytoluene, 2,6-dimethylsulfonyloxytoluene, 2,4-dichlorobenzotrifluoride, 3,5-dichlorobenzotrifluoride, 1,3-dibromo-2,4,5,6-tetrafluorobenzene, and compounds corresponding to the above compounds in which the chlorine atom is replaced with a bromine atom or an iodine atom.

The polyarylene is prepared by reacting the above monomers in the presence of a catalyst. The catalyst used herein is a catalyst system containing a transition metal compound. This catalyst system contains, as essential components, (1) a transition metal salt and a compound which becomes a ligand (referred to as a “ligand component” hereinafter), or a transition metal complex (including a copper salt) wherein a ligand is coordinated, and (2) a reducing agent. In order to increase the polymerization rate, a “salt” may be added.

The polyarylene can be adjusted to a prescribed molecular weight using, as a molecular weight modifier, a compound having a halogen (except fluorine) at one terminal, such as 4-chlorobenzophenone.

Examples of the transition metal salts include nickel compounds, such as nickel chloride, nickel bromide, nickel iodide and nickel acetylacetonate; palladium compounds, such as palladium chloride, palladium bromide and palladium iodide; iron compounds, such as iron chloride, iron bromide and iron iodide; and cobalt compounds, such as cobalt chloride, cobalt bromide and cobalt iodide. Of these, particularly preferable are nickel chloride, nickel bromide and the like.

Examples of the ligand components include triphenylphosphine, 2,2′-bipyridine, 1,5-cyclooctadiene and 1,3-bis(diphenylphosphino)propane. Of these, preferable are triphenylphosphine and 2,2′-bipyridine. The ligand components can be used singly or in combination of two or more kinds.

Examples of the transition metal complexes wherein a ligand is coordinated include nickel chloride-bis(triphenylphosphine), nickel bromide-bis(triphenylphosphine), nickel iodide-bis(triphenylphosphine), nickel nitrate-bis(triphenylphosphine), nickel chloride(2,2′-bipyridine), nickel bromide(2,2′-bipyridine), nickel iodide(2,2′-bipyridine), nickel nitrate(2,2′-bipyridine), bis(1,5-cyclooctadiene)nickel, tetrakis(triphenylphosphine)nickel, tetrakis(triphenylphosphite)nickel and tetrakis(triphenylphosphine)palladium. Of these, preferable are nickel chloride-bis(triphenylphosphine) and nickel chloride(2,2′-bipyridine).

Examples of the reducing agents employable in the catalyst system include iron, zinc, manganese, aluminum, magnesium, sodium and calcium. Of these, zinc, magnesium and manganese are preferable. These reducing agents can be used after they are brought into contact with an acid such as an organic acid to further activate them.

Examples of the “salts” employable in the catalyst system include sodium compounds, such as sodium fluoride, sodium chloride, sodium bromide, sodium iodide and sodium sulfate; potassium compounds, such as potassium fluoride, potassium chloride, potassium bromide, potassium iodide and potassium sulfate; and ammonium compounds, such as tetraethylammonium fluoride, tetraethylammonium chloride, tetraethylammonium bromide, tetraethylammonium iodide and tetraethylammonium sulfate. Of these, preferable are sodium bromide, sodium iodide, potassium bromide, tetraethylammonium bromide and tetraethylammonium iodide.

The amounts of the components used are as follows. The amount of the transition metal salt or the transition metal complex is in the range of usually 0.0001 to 10 mol, preferably 0.01 to 0.5 mol, based on 1 mol of the total of the monomers. If the amount thereof is less than 0.0001 mol, the polymerization reaction does not proceed sufficiently in some cases. If the amount thereof exceeds 10 mol, the molecular weight is sometimes lowered.

When the transition metal salt and the ligand component are used in the catalyst system, the amount of the ligand component is in the range of usually 0.1 to 100 mol, preferably 1 to 10 mol, based on 1 mol of the transition metal salt. If the amount thereof is less than 0.1 mol, the catalytic activity sometimes becomes insufficient. If the amount thereof exceeds 100 mol, the molecular weight of the resulting polyarylene is sometimes lowered.

The amount of the reducing agent is in the range of usually 0.1 to 100 mol, preferably 1 to 10 mol, based on 1 mol of the total of the monomers. If the amount thereof is less than 0.1 mol, the polymerization does not proceed sufficiently in some cases. If the amount thereof exceeds 100 mol, purification of the resulting polyarylene sometimes becomes difficult.

When the “salt” is used, the amount of the salt is in the range of usually 0.001 to 100 mol, preferably 0.01 to 1 mol, based on 1 mol of the total of the monomers. If the amount thereof is less than 0.001 mol, the effect in increase of the polymerization rate is sometimes insufficient. If the amount thereof exceeds 100 mol, purification of the resulting polyarylene sometimes becomes difficult.

Examples of the polymerization solvents employable include tetrahydrofuran, cyclohexanone, dimethyl sulfoxide, N,N-dimethylformamide, N,N-dimethylacetamide, N-methyl-2-pyrrolidone and y-butyrolactone. Of these, preferable are tetrahydrofuran, N,N-dimethylformamide, N,N-dimethylacetamide and N-methyl-2-pyrrolidone. It is preferable to use these polymerization solvents after drying them sufficiently.

The total concentration of the monomers in the polymerization solvent is in the range of usually 1 to 90% by weight, preferably 5 to 40% by weight.

The polymerization temperature is in the range of usually 0 to 200° C., preferably 50 to 120° C., and the polymerization time is in the range of usually 0.5 to 100 hours, preferably 1 to 40 hours.

By the polymerization of the monomer (A) represented by the formula (A) and at least one monomer (B) selected from the monomers represented by the formulas (B-1) to (B-4) as described above, a polymerization solution containing polyarylene is obtained.

The sulfonated polyarylene for use in the invention can be obtained by introducing a sulfonic acid group into the above copolymer having no sulfonic acid group in a conventional manner using a sulfonating agent.

The sulfonic acid group can be introduced by sulfonating the copolymer having no sulfonic acid group using a known sulfonating agent, such as anhydrous sulfuric acid, fuming sulfuric acid, chlorosulfonic acid, sulfuric acid or sodium hydrogensulfite, under the conditions publicly known (see Polymer Preprints, Japan, vol. 42, No. 3, p. 730 (1993), Polymer Preprints, Japan, vol. 42, No. 3, p. 736 (1994), Polymer Preprints, Japan, vol. 42, No. 3, pp. 2490-2493 (1993)).

That is to say, in order to perform the sulfonation, the copolyarylene having no sulfonic acid group is reacted with the sulfonating agent in the presence or absence of a solvent. Examples of the solvents include hydrocarbon solvents, such as n-hexane; ether solvents, such as tetrahydrofuran and dioxane; non-protonic polar solvents, such as N,N-dimethylacetamide, N,N-dimethylformamide and dimethyl sulfoxide; and halogenated hydrocarbons, such as tetrachloroethane, dichloroethane, chloroform and methylene chloride. Although the reaction temperature is not specifically restricted, it is in the range of usually −50 to 200° C., preferably −10 to 100° C. The reaction time is in the range of usually 0.5 to 1,000 hours, preferably 1 to 200 hours.

The amount of the sulfonic acid group in the sulfonated polyarylene thus obtained is in the range of 0.5 to 3 mg equivalent/g, preferably 0.8 to 2.8 mg equivalent/g. If the amount thereof is less than 0.5 mg equivalent/g, the proton conductivity is not increased. If the amount thereof exceeds 3 mg equivalent/g, hydrophilicity is so increased that the resulting polymer becomes a water-soluble polymer or that the durability is lowered even if the polymer does not become water-soluble.

The amount of the sulfonic acid group can be readily controlled by changing the proportion between the monomer (A) and the monomer (B), and the type and combination of the monomer (B).

The prepolymer of the sulfonated polyarylene obtained as above has, before the sulfonation, a weight-average molecular weight of 10,000 to 1,000,000, preferably 20,000 to 800,000, in terms of polystyrene. If the molecular weight is less than 10,000, film performance is so insufficient that cracks occur in the molded film, and besides, there is a problem of mechanical properties. If the molecular weight exceeds 1,000,000, insufficient solubility and high solution viscosity are brought about, resulting in bad processability.

The thickness of the sulfonated polyarylene layer (thin film 2) obtained from the sulfonated polyarylene is in the range of usually 10 to 200 μm, preferably 10 to 50 μm.

<Process for Producing Electrolyte Membrane/Electrode Bonded Structure>

In the process for producing the first electrolyte membrane-bonded electrode according to the invention, a water-containing dispersion of a perfluorosulfonic acid polymer is applied onto an electrode and dried to form a thin film 1 comprising the perfluorosulfonic acid polymer, and then a sulfonated polyarylene solution is applied onto the thin film 1 and dried to form a thin film 2 comprising the sulfonated polyarylene, whereby an electrolyte membrane comprising the thin film 1 and the thin film 2 is formed.

In order to form the thin film 1, a water-containing dispersion having a perfluorosulfonic acid polymer concentration of 0.5 to 20% by weight, preferably 0.5 to 18% by weight, is applied onto the electrode and dried. When the concentration of the perfluorosulfonic acid polymer in the water-containing dispersion is in the above range, the dispersion does not penetrate into the electrode layer, and a barrier layer effectively inhibiting penetration of the subsequently applied sulfonated polyarylene into the electrode can be formed.

If the concentration of the perfluorosulfonic acid polymer exceeds 20% by weight, a homogeneous water-containing dispersion cannot be obtained, and hence, film formation becomes difficult. If the concentration thereof is less than 0.5% by weight, pinholes are liable to be formed in the resulting film, and hence, the resulting film cannot function as a barrier to the sulfonated polyarylene.

The dispersion medium to disperse therein the perfluorosulfonic acid polymer contains an organic solvent A and water. The organic solvent A used herein is a solvent that is hydrophilic and has a boiling point of not higher than 150° C., such as methanol, ethanol, n-propyl alcohol, i-propyl alcohol, tetrahydrofuran, dioxane, dimethoxyethane, acetone or methyl ethyl ketone.

The water content in the dispersion medium is in the range of 5 to 95% by weight, preferably 10 to 80% by weight.

Examples of the methods to apply the water-containing dispersion of the perfluorosulfonic acid polymer onto the electrode include bar coating, doctor blade coating and spray coating. Of these, spray coating is preferable.

After application of the water-containing dispersion of the perfluorosulfonic acid polymer, the coating film is usually dried. However, it is possible to form the thin film 2 without drying the coating film. The drying temperature is in the range of usually 50 to 150° C., preferably 60 to 130° C.

The thin film 2 is formed by applying a solution of the sulfonated polyarylene in an organic solvent B onto the thin film 1 and drying it.

Examples of the organic solvents B include tetrahydrofuran, cyclohexanone, dimethyl sulfoxide, N,N-dimethylformamide, N,N-dimethylacetamide, N-methyl-2-pyrrolidone, γ-butyrolactone and γ-butyrolactam. Of these, preferable are tetrahydrofuran, N,N-dimethylformamide, N,N-dimethylacetamide and N-methyl-2-pyrrolidone.

Also available as the organic solvents B are mixtures of the above-exemplified organic solvents and an alcohol having a boiling point of not higher than 100° C., such as a mixture of methanol and N-methyi-2-pyrrolidone. In this case, the proportion of the alcohol having a boiling point of not higher than 100° C. is preferably not more than 75% by weight based on the whole organic solvent.

The solution of the sulfonated polyarylene has a concentration of usually 5 to 50% by weight, preferably 8 to 30% by weight.

It is preferable to apply the solution of the sulfonated polyarylene by a doctor blade, and after the application, the coating film is dried at a temperature of usually 50 to 150° C., preferably 60 to 130° C.

The thickness of the thin film 2 is in the range of usually 1 to 300 μm, preferably 2 to 100 μm.

Through the above process, an electrolyte membrane-bonded electrode, in which the electrolyte membrane comprising the thin film 1 comprising the perfluorosulfonic acid polymer and the thin film 2 comprising the sulfonated polyarylene is formed on the electrode, is produced.

<Process for Producing Second Electrolyte Membrane-Bonded Electrode>

Next, a process for producing a second electrolyte membrane-bonded electrode according to the invention is described.

In the process for producing the second electrolyte membrane-bonded electrode according to the invention, two kinds of proton-conductive polymer solutions or dispersions having different water contents are applied onto the aforesaid electrode and dried to form an electrolyte membrane layer, whereby an electrolyte membrane-bonded electrode is produced.

<Proton-Conductive Polymer>

Examples of the proton-conductive polymers for constituting the electrolyte layer in the process for producing the second electrolyte membrane-bonded electrode include sulfonated polyarylene, sulfonated polyarylene ether, sulfonated polyarylene ketone, sulfonated polyether ether ketone, polyimide, sulfonated polybenzimidazole, and sulfonated products of perfluorohydrocarbonic tetrafluoroethylene copolymers. In order to obtain an electrolyte membrane-bonded electrode having excellent electrical characteristics, it is preferable to use the aforesaid sulfonated polyarylene.

<Process for Producing Electrolyte Membrane-Bonded Electrode>

In the process for producing the second electrolyte membrane-bonded electrode according to the invention, a proton-conductive polymer solution or dispersion (referred to as a “varnish composition 3” hereinafter) containing an organic solvent B and water and having a water content of 25 to 50% by weight is applied onto an electrode and dried to form a thin film 3 comprising the proton-conductive polymer, and then a proton-conductive polymer solution or dispersion (referred to as a “varnish composition 4” hereinafter) containing an organic solvent B and water and having a water content of less than 25% by weight is applied onto the thin film 3 and dried to form a thin film 4 comprising the proton-conductive polymer, whereby an electrolyte membrane comprising the thin film 3 and the thin film 4 is formed.

The varnish composition 3 applied onto the electrode has a water content of 25 to 45% by weight, preferably 25 to 40% by weight, a proton-conductive polymer content of 1 to 10% by weight, preferably 1 to 8% by weight, and an organic solvent B content of 50 to 70% by weight.

Examples of the organic solvents B include the same solvents as described above, and it is preferable to use tetrahydrofuran, N,N-dimethylformamide, N,N-dimethylacetamide, N-methyl-2-pyrrolidone or the like.

If the water content in the varnish composition 3 is less than 25% by weight, the effect in inhibition of penetration phenomenon of the subsequently applied varnish composition 4 into the electrode layer is low. If the water content exceeds 50% by weight, the sulfonated polyarylene is not dissolved or dispersed homogeneously, and it becomes difficult to form a uniform film.

Examples of the methods to apply the varnish composition 3 onto the electrode include bar coating, spray coating and the like. Of these, spray coating is preferable.

After application of the varnish composition 3, the coating film is dried at a temperature of 50 to 150° C., preferably 60 to 130° C.

The thickness of the thin film 3 obtained from the varnish composition 3 is in the range of usually 0.1 to 10 μm, preferably 0.2 to 8 μm.

Then, onto the thin film 3 obtained from the varnish composition 3, the varnish composition 4 is applied.

The varnish composition 4 has a water content of less than 25% by weight, preferably 10 to 20% by weight, a proton-conductive polymer content of 3 to 50% by weight, preferably 5 to 30% by weight, and an organic solvent B content of 60 to 85% by weight, preferably 65 to 80% by weight.

The difference in the water content (% by weight) between the varnish composition 3 and the varnish composition 4 is preferably not less than 5% by weight.

Examples of the organic solvents B include the same solvents as used for the varnish composition 3.

If the water content in the varnish composition 4 is not less than 25% by weight, the concentration of the sulfonated polyarylene in the varnish composition 4 cannot be increased sufficiently, and hence, it becomes impossible to form an excellent electrolyte layer.

The varnish composition 4 can be applied by bar coating, doctor blade coating or the like. After the application, the coating film is dried at a temperature of usually 50 to 180° C., preferably 80 to 150° C.

The thickness of the thin film 4 obtained from the varnish composition 4 is in the range of usually 5 to 200 μm, preferably 10 to 100 μm.

In the present invention, after formation of the film comprising the varnish composition 4, a third varnish composition (referred to as a “varnish composition 5” hereinafter) may be further applied.

The varnish composition 5 is a solution obtained by dissolving a proton-conductive polymer in a mixed solvent consisting essentially of an alcohol having a boiling point of not higher than 100° C. and an organic solvent E having a boiling point of higher than 100° C.

Examples of the proton-conductive polymers used herein include the same proton-conductive polymers as used in the preparation of the aforesaid varnish composition 3 or 4, and preferable is sulfonated polyarylene.

Examples of the alcohols having a boiling point of not higher than 100° C. include methanol, ethanol, propanol and isopropyl alcohol.

Examples of the organic solvents E having a boiling point of higher than 100° C. include N,N-dimethylformamide, N,N-dimethylacetamide, N-methyl-2-pyrrolidone, γ-butyrolactone, tetramethylurea, dimethyl sulfoxide, hexamethylphosphoric triamide and sulfolane.

In the present invention, the weight ratio between the alcohol having a boiling point of not higher than 100° C. and the organic solvent E having a boiling point of higher than 100° C. is in the range of 5-75:95-′25, with the proviso that the total is 100.

The concentration of the proton-conductive polymer in the varnish composition 5 is in the range of 1 to 50% by weight, preferably 3 to 30% by weight.

Examples of the methods to apply the varnish composition 5 onto the thin film 4 include bar coating and spray coating. The thickness of the coating film of the varnish composition 5 is in the range of 1 to 100 μm.

The coating film of the varnish composition 5 can be heated and dried at a temperature of 50 to 200° C., preferably 50 to 150° C., for a period of 15 minutes to 3 hours, preferably 30 minutes to 2 hours.

Through the above process, an electrolyte membrane-bonded electrode, in which the electrolyte membrane comprising the thin film 3 obtained from the varnish composition 3, the thin film 4 obtained from the varnish composition 4, and if necessary, the thin film 5 obtained from the varnish composition 5 is formed on the electrode, is produced.

<Process for Producing Third Electrolyte Membrane-Bonded Electrode>

Next, a process for producing a third electrolyte membrane-bonded electrode according to the invention is described.

In the process for producing the third electrolyte membrane-bonded electrode according to the invention, a varnish composition 6 obtained by dissolving a sulfonated polymer in a solvent containing an organic solvent C, an organic solvent D and water is applied onto an electrode and dried to form an electrolyte membrane layer comprising the sulfonated polymer, whereby an electrolyte membrane-bonded electrode is produced.

The varnish composition 6 for use in the process for producing the third electrolyte membrane-bonded electrode according to the invention is a varnish composition obtained by dissolving a sulfonated polymer in a solvent containing an organic solvent C, an organic solvent D and water.

<Sulfonated Polymer>

Examples of the sulfonated polymers employable in the invention include a non-perfluorohydrocarbonic sulfonated polymer and a sulfonated polymer having a polyarylene structure in its main chains.

Examples of the non-perfluorohydrocarbonic sulfonated polymers include sulfonated polymers other than Nafion (trade name, available from DuPont Co.), Flemion (trade name, available from Asahi Glass Co., Ltd.), Aciplex (trade name, available from Asahi Chemical Industry Co., Ltd.) and a perfluorohydrocarbonic sulfonic acid polymer represented by the following formula,

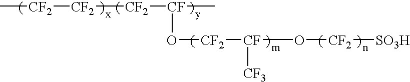

which is known as available from Dow Co., said non-perfluorohydrocarbonic sulfonated polymers being sulfonated polymers other than the following sulfonated polymer having a polyarylene structure in its main chain.

More specifically, there can be mentioned sulfonic acid derivatives, such as polyether, polyketone, polysulfone, polyamide and polyimide; and other sulfonic acid derivatives, such as polyether ketone, polyether imide and polyamide imide.

The sulfonated polymer having a polyarylene structure in its main chain is, for example, the aforesaid sulfonated polyarylene.

In the varnish composition 6 employable in the invention, the above-mentioned sulfonated polymer is dissolved in a solvent containing an organic solvent C, an organic solvent D and water.

<Organic Solvent C>

The organic solvent C is a good solvent for the sulfonated polymer and is a solvent having a higher boiling point than that of other solvent components (organic solvent D and water). As the organic solvent C, a non-protonic dipole solvent having a dielectric constant of not less than 20, preferably not less than 30, is preferably employed.

When the dielectric constant of the organic solvent C is not less than 20, homogeneity of the varnish composition can be maintained even in the concentration step or the drying step, and the varnish composition 6 having excellent homogeneity can form a uniform and dense film.

If the dielectric constant of the organic solvent C is less than 20, the sulfonated polymer is sometimes precipitated in the concentration step and the drying step, and it becomes difficult to form a uniform film.

Examples of the non-protonic dipole solvents appropriate to the organic solvent C include N,N-dimethylformamide (boiling point: 153° C., dielectric constant: 36.71), N,N-dimethylacetamide (boiling point: 166° C., dielectric constant: 37.78), N-methyl-2-pyrrolidone (boiling point: 202° C., dielectric constant: 32), γ-butyrolactone (boiling point: 204° C., dielectric constant: 39), tetramethylurea (boiling point: 177° C., dielectric constant: 30 or more), dimethyl sulfoxide (boiling point: 189° C., dielectric constant: 46.68), hexamethylphosphoric triamide (boiling point: 233° C., dielectric constant: 30) and sulfolane (boiling point: 287° C., dielectric constant: 43.3).

With regard to the dielectric constants mentioned above, data described in “Organic Solvents” by Riddick and Bunger (Wiley-Interscience) (1970) can be used.

<Organic Solvent (D)>

The organic solvent D has a boiling point of not lower than 50° C. and is not a good solvent for the sulfonated polymer when used alone but causes a solubility region of the sulfonated polymer to appear when mixed with the organic solvent C and/or water. The upper limit of the boiling point of the organic solvent D is lower than the boiling point of the organic solvent C that is used at the same time.

Examples of solvents appropriate to the organic solvent D include those having a solubility parameter (SP) of 7 to 14.5 (cal/mol) ¹², preferably 7.5 to 13.0 (cal/mol)^{1/2}, having a boiling point of not lower than 50° C., preferably not lower than 60° C. and having a functional group of alcohol, ether or ketone.

If the boiling point of the organic solvent D is lower than 50° C., the solvent constituent in the varnish composition 6 is liable to vary during the formation of a film from the varnish composition 6.

When the solubility parameter (SP) of the organic solvent D is in the range of 7 to 14.5 (cal/mol)^{1/2}, the organic solvent D does not dissolve the sulfonated polymer when used alone, but when the organic solvent D is combined with the organic solvent C and water, the working range wherein the organic solvent D can dissolve the sulfonated polymer appears.

With regard to the solubility parameters used herein, values described in “Science of Coating” by Yuji Haraguchi, pp. 65-68, can be used. The solubility parameters of the compounds, which are not described in this publication, can be determined by the calculation of Fedors (R. F. Fedors, Polymer Eng. Sci., vol. 14, p. 147 (1974)).

More specifically, the organic solvent D can be selected from methanol (boiling point: 65° C., SP: 14.28 (cal/mol)^{1/2}), ethanol (boiling point: 78° C., SP: 12.92 (cal/mol)^{1/2}), 1-propanol (boiling point: 97° C., SP: 11.97 (cal/mol)^{1/2}), 2-propnaol (boiling point: 82° C., SP: 11.50 (cal/mol)^{1/2}), n-butanol (boiling point: 118° C., SP: 11.30 (cal/mol)^{1/2}), i-butanol (boiling point: 108° C., SP: 11.11 (cal/mol)^{1/2}), sec-butanol (boiling point: 100° C., SP: 11.0 (cal/mol)^{1/2}), amyl alcohol (boiling point: 138° C., SP: 10.61 (cal/mol)^{1/2}), 2-pentanol (boiling point: 119° C., SP: 11.85 (cal/mol)^{1/2} (calculated value)), 3-pentanol (boiling point: 115° C., SP: 11.85 (cal/mol)^{1/2} (calculated value)), 2-methyl-1-butanol (boiling point: 129° C., SP: 11.85 (cal/mol)^{1/2} (calculated value)), 3-methyl-1-butanol (boiling point: 131° C., SP: 11.85 (cal/mol)^{1/2} (calculated value)), 2,2-dimethyl-1-propanol (boiling point: 113° C., SP: 11.37 (cal/mol)^{1/2} (calculated value)), tetrahydrofuran (THF) (boiling point: 66° C., SP: 9.52 (cal/mol)^{1/2}), tetrahydropyran (boiling point: 88° C., SP: 8.32 (cal/mol)^{1/2} (calculated value)), 1,3-dioxolan (boiling point: 76° C., SP: 8.66 (cal/mol)^{1/2} (calculated value)), 1,4-dioxane (boiling point: 101° C., SP: 10.0 (cal/mol)^{1/2}), dimethoxyethane (monoglyme) (boiling point: 93° C., SP: 7.63 (cal/mol)^{1/2} (calculated value)), bis(2-methoxyethyl)ether (diglyme) (boiling point: 160° C., SP: 8.10 (cal/mol)^{1/2} (calculated value)), acetal (boiling point: 104° C., SP: 7.65 (cal/mol)^{1/2} (calculated value)), acetone (boiling point: 56° C., SP: 9.77 (cal/mol)^{1/2}), methyl ethyl ketone (boiling point: 80° C., SP: 9.27 (cal/mol)^{1/2}), 3-pentanone (boiling point: 102° C., SP: 8.92 (cal/mol)^{1/2} (calculated value)), cyclopentanone (boiling point: 130° C., SP: 10.00 (cal/mol)^{1/2} (calculated value)), cyclohexanone (boiling point: 156° C., SP: 9.88 (cal/mol)^{1/2}), acetophenone (boiling point: 202° C., SP: 9.68 (cal/mol)^{1/2}), 2-methoxyethanol (methyl cellosolve) (boiling point: 125° C., SP: 11.98 (cal/mol)^{1/2} (calculated value)), 2-ethoxyethanol (cellosolve) (boiling point: 136° C., SP: 11.47 (cal/mol)^{1/2} (calculated value)), 2-butoxyethanol (butyl cellosolve) (boiling point: 170° C., SP: 10.81 (cal/mol)^{1/2} (calculated value)) and diacetone alcohol (boiling point: 168° C., SP: 10.18 (cal/mol)^{1/2}) Of these, preferable are ethanol, 1-propanol, 2-propnaol, tetrahydrofuran, 1,3-dioxolan, dimethoxyethane, acetone, methyl ethyl ketone and cyclohexanone.

In case of a varnish composition comprising only the sulfonated polymer and the organic solvent C, a homogeneous solution is obtained, but when this solution is applied onto the electrode layer, repelling takes place. If water is allowed to be present, uniform coating becomes feasible. In this case, however, a high-concentration solution of the sulfonated polymer cannot be prepared, and therefore, it is necessary to apply the solution many times in order to obtain a desired thickness. In addition, the constituent range of a homogeneous varnish composition is extremely narrow, so that if the application is repeated, the polymer coating becomes heterogeneous because of variation of the varnish constituent. Further, there is another problem that, during the storage, the polymer is precipitated by variation of the varnish constituent that is caused by moisture absorption.

By the use of the varnish composition obtained by introducing water into a sulfonated polymer solution, application of the varnish composition onto the electrode layer can be carried out without repelling, and thereby a uniform electrolyte membrane can be formed on the electrode. Moreover, the resulting membrane-electrode assembly has a feature that the power generation property is not lowered as compared with an assembly obtained by the use of a varnish containing no water.

In the present invention, the weight ratio among the organic solvent C, the organic solvent D and water used is in the range of 20-85:10-75:5-70, preferably 25-75:15-75:7-55, with the proviso that the total is 100.

The concentration of the sulfonated polymer in the varnish composition 6 is in the range of 1 to 50% by weight, preferably 3 to 30% by weight.

When the ratio among the organic solvent C, the organic solvent D and water is in the above range, the mixed solvent can dissolve the sulfonated polymer. By the use of both the organic solvent C and the organic solvent D, it becomes feasible to introduce water into the varnish composition 6, and hence, penetration of the sulfonated polymer into the electrode can be inhibited when the varnish composition 6 is applied onto the electrode.

The varnish composition 6 can be prepared by mixing and stirring the sulfonated polymer, the organic solvent C, the organic solvent D, water, and if desired, other components in a conventional manner.

The varnish composition 6 is favorably used for forming a proton-conductive membrane.

In order to use the varnish composition 6 for an electrolyte membrane of a fuel cell, an electrode layer is first formed, and then the varnish composition 6 is applied onto the electrode and dried.

The electrode which can be coated with the varnish composition 6 is, for example, the aforesaid electrode.

The varnish composition 6 of the invention can be applied one or more times to form a coating film having a thickness of 1 to 100 μm, and the coating film can be heated and dried at a temperature of 50 to 200° C., preferably 50 to 150° C., for a period of 15 minutes to 3 hours, preferably 30 minutes to 2 hours.

Examples of the methods to apply the varnish composition 6 include bar coating and spray coating.

The term “drying” used herein sometimes means that the solvent does not completely evaporate and partly remains.

In the present invention, it is possible that the varnish composition 6 is applied onto the electrode and dried to form an electrolyte membrane and then a varnish composition (referred to as a “varnish composition 7” hereinafter) different from the varnish composition 6 in the constituent is applied onto the resulting electrolyte membrane and dried to form two-layer electrolyte membrane.

As the varnish composition 7, a varnish composition obtained by dissolving a sulfonated polymer instead of the proton-conductive polymer in the varnish composition 5 is employed.

The same sulfonated polymer as used for producing the varnish composition 5 is used for varnish composition 7.

The concentration of the sulfonated polymer in the varnish composition 7 is in the range of 1 to 50% by weight, preferably 3 to 30% by weight.

The varnish composition 7 can be applied onto the electrolyte membrane formed from the varnish composition 6 by, for example, bar coating or spray coating, and the thickness of the coating film obtained from the varnish composition 7 is in the range of 1 to 100 μm.

After application of the varnish composition 7, the coating film is heated and dried at a temperature of 50 to 200° C., preferably 50 to 150° C., for a period of 15 minutes to 3 hours, preferably 30 minutes to 2 hours, to obtain an electrolyte membrane of the varnish composition 7.

By forming a layer of the varnish composition 7 in the invention, bubbles produced when the varnish composition 6 having been first applied onto the electrode layer is dried can be filled with the organic solvent E in the varnish composition 7, and hence, occurrence of cross-leak due to the bubbles can be reduced. As a result, a more excellent electrolyte membrane-bonded electrode can be produced.

Through the above process, an electrolyte membrane-bonded electrode, in which the electrolyte membrane comprising a thin film 6 obtained from the varnish composition 6 and if necessary a thin film 7 obtained from the varnish composition 7 is formed on the electrode, is produced.

### EXAMPLES

The present invention is further described with reference to the following examples, but it should be construed that the invention is in no way limited to those examples.

### Preparation Example 1

### To Prepare Water-Containing Dispersion

In a 250 ml plastic bottle, 1.5 g of a perfluorosulfonic acid polymer (trade name: Nafion 117, available from Aldrich Co.), 75.5 g of distilled water, 5.0 g of methanol, 9.0 g of i-propyl alcohol and 9.0 g of n-propyl alcohol were placed, and they were stirred for 10 hours at room temperature by a wave rotor to obtain a water-containing dispersion (referred to as a “water-containing dispersion 1” hereinafter) having a viscosity of 52 mPa·s (25° C.) and a perfluorosulfonic acid polymer concentration of 1.5% by weight.

### Preparation Example 2

### To Prepare Water-Containing Dispersion

In a 250 ml plastic bottle, 4.0 g of a perfluorosulfonic acid polymer (trade name: Nafion 117, available from Aldrich Co.), 68.0 g of distilled water, 6.0 g of methanol, 11.0 g of i-propyl alcohol and 11.0 g of n-propyl alcohol were placed, and they were stirred for 10 hours at room temperature by a wave rotor to obtain a water-containing dispersion (referred to as a “water-containing dispersion 2” hereinafter) having a viscosity of 70 mPa·s (25° C.) and a perfluorosulfonic acid polymer concentration of 4.0% by weight.

### Preparation Example 1

### To Prepare Sulfonated Polyarylene Vvarnish

In a 250 ml plastic bottle was placed 10 g of a sulfonation product (sulfonic acid concentration (also referred to as “IEC” hereinafter): 2.10 meq/g) of a copolymer (Mn=50,000, Mw=150,000) of 2,5-dichloro-4′-(4-phenoxy)phenoxybenzophenone (referred to as “2,5-DCPPB” hereinafter) and a compound represented by the following formula (a) (referred to as “oligo-BCPAF” hereinafter, Mn=11,200, Mw=27,500), wherein the molar ratio between 2,5-DCPPB and oligo-BCPAF was 97:3.

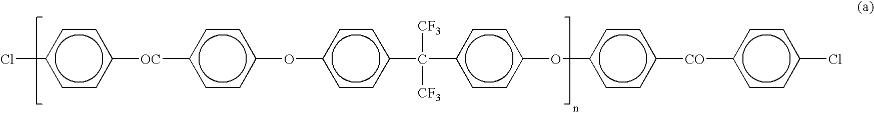

To the sulfonation product, 45 g of methanol and 45 g of N-methyl-2-pyrrolidone (NMP) were added, and they were stirred for 20 hours by a wave rotor to obtain a sulfonated polyarylene varnish (referred to as a “varnish A” hereinafter) having a viscosity of 3,050 mPa·s (25° C.).

### Preparation Example 2

### To Prepare Sulfonated Polyarylene Varnish

A sulfonated polyarylene varnish (referred to as a “varnish B” hereinafter) having a viscosity of 2,230 mPa·s (25° C.) was obtained in the same manner as in the above preparation of the varnish A, except that 90 g of NMP only was used instead of 45 g of methanol and 45 g of N-methyl-2-pyrrolidone.

<Evaluation methods>

(Observation of Section)

The electrolyte membrane-bonded electrode is cut with a microtome to expose a cross-section. The cross-section is observed by a scanning electron microscope (SEM) to examine a degree of penetration of the varnish component into the electrode layer.

(Measurement of Specific Surface Area of All Pores)

The specific surface area of all the pores in the electrode layer of the electrolyte membrane-bonded electrode is measured by a mercury penetration method using an automatic porosimeter.

(Preparation of Fuel Cell and Evaluation of Performance)

Electrolyte membrane-bonded electrodes are laminated in such a manner that the varnish coating surfaces face each other, to prepare a membrane-electrode assembly. Then, the membrane-electrode assembly thus prepared is sandwiched between two collectors made of titanium, and outside the collectors, heaters are arranged to constitute a fuel cell having an effective area of 25 cm². The temperature of the fuel cell is maintained at 80° C. To the fuel electrode is fed hydrogen at a humidity of 0% RH and 2 atm, and to the oxidation electrode is fed oxygen at a humidity of 65% RH and 2 atm. When the current density is 1 A/cm², a terminal voltage is measured, and the measured terminal voltage is taken as an initial voltage.

### Example 1

The water-containing dispersion 1 was applied onto a catalyst layer of a 1 mg/cm² platinum-supported gas diffusion electrode (manufactured by U.S. Electrochem Inc.) by spray coating using a spray, and then dried under heating at 100° C. for 30 minutes to form a perfluorosulfonic acid polymer thin film having a thickness of 0.3 μm.

Subsequently, the varnish A was applied onto the thin film prepared from the water-containing dispersion 1 by coater coating using a doctor blade, and then dried under heating at 100° C. for 1 hour to form a sulfonated polyarylene film having a thickness of 40 μm. Thus, an electrolyte membrane-bonded electrode was prepared.

The electrolyte membrane-bonded electrode was cut with a microtome to expose a cross-section, and the cross-section was observed by a scanning electron microscope (SEM). As a result, penetration of the electrolyte into the electrode layer was not found.

Further, the specific surface area of all the pores in the electrode layer of the electrolyte membrane-bonded electrode was measured by a mercury penetration method using an automatic porosimeter. As a result, variation of the specific surface area of all the pores was scarcely found.

A membrane-electrode assembly was prepared in the aforesaid manner, and using the assembly, a fuel cell was constituted. Then, the initial voltage of the fuel cell was measured, and as a result, it was 0.60 V.

The result of observation of the cross-section of the electrolyte membrane-bonded electrode by means of SEM, the result of measurement of the specific surface area of all pores, and power generation property of the membrane-electrode assembly are set forth in Table 1.

### Example 2

Using the water-containing dispersion 1, a perfluorosulfonic acid polymer thin film having a thickness of 0.3 μm was formed in the same manner as in Example 1. Then, using the varnish B, a sulfonated polyarylene film having a thickness of 40 μm was formed in the same manner as in Example 1. Thus, an electrolyte membrane-bonded electrode was prepared. Then, using the bonded electrodes, a membrane-electrode assembly was prepared. The result of SEM observation of the cross-section of the electrolyte membrane-bonded electrode, the result of measurement of the specific surface area of all pores, and power generation property of the membrane-electrode assembly are set forth in Table 1.

### Example 3

Using the water-containing dispersion 2, a perfluorosulfonic acid polymer thin film having a thickness of 0.3 μm was formed in the same manner as in Example 1. Then, using the varnish A, a sulfonated polyarylene film having a thickness of 40 μm was formed in the same manner as in Example 1. Thus, an electrolyte membrane-bonded electrode was prepared. Then, using the bonded electrodes, a membrane-electrode assembly was prepared. The result of SEM observation of the cross-section of the electrolyte membrane-bonded electrode, the result of measurement of the specific surface area of all pores, and power generation property of the membrane-electrode assembly are set forth in Table 1.

### Example 4

Using the water-containing dispersion 2, a perfluorosulfonic acid polymer thin film having a thickness of 0.3 μm was formed in the same manner as in Example 1. Then, using the varnish B, a sulfonated polyarylene film having a thickness of 40 μm was formed in the same manner as in Example 1. Thus, an electrolyte membrane-bonded electrode was prepared. Then, using the bonded electrodes, a membrane-electrode assembly was prepared. The result of SEM observation of the cross-section of the electrolyte membrane-bonded electrode, the result of measurement of the specific surface area of all pores, and power generation property of the membrane-electrode assembly are set forth in Table 1.

### Comparative Example 1

An electrolyte membrane-bonded electrode and a membrane-electrode assembly were prepared in the same manner as in Example 1, except that the water-containing dispersion 1 was not used. The result of SEM observation of the cross-section of the electrolyte membrane-bonded electrode, the result of measurement of the specific surface area of all pores, and power generation property of the membrane-electrode assembly are set forth in Table 1.

### Comparative Example 2

An electrolyte membrane-bonded electrode and a membrane-electrode assembly were prepared in the same manner as in Example 2, except that the water-containing dispersion 1 was not used. The result of SEM observation of the cross-section of the electrolyte membrane-bonded electrode, the result of measurement of the specific surface area of all pores, and power generation property of the membrane-electrode assembly are set forth in Table 1.

TABLE 1

| | | | Result of | Specific | |
|---|---|---|---|---|---|
| | Water- | Sulfonated | cross- | surface area | Initial |
| | containing | polyarylene | section ob- | of all pores | voltage |
| | dispersion | varnish | servation *1 | (m²/cm²) | (V) |
| Ex. 1 | 1 | A | AA | 5.68 | 0.60 |
| Ex. 2 | 1 | B | AA | 5.60 | 0.60 |
| Ex. 3 | 2 | A | AA | 5.64 | 0.61 |
| Ex. 4 | 2 | B | AA | 5.70 | 0.60 |
| Comp. | none | A | BB | 1.48 | 0.55 |
| Ex. 1 | | | | | |
| Comp. | none | B | BB | 0.45 | 0.52 |
| Ex. 2 | | | | | |
| Ref. *2 | — | — | — | 5.78 | — |

*1 AA: The electrolyte did not penetrate into the electrode layer.
BB: The electrolyte penetrated into the electrode layer.
*2 Ref.: specific surface area of all pores in the electrode before thin film formation

### Preparation Example 3

### To Prepare Sulfonated Polyarylene Varnish

In a 250 ml plastic bottle, 2 g of the same sulfonation product of a copolymer of 2,5-DCPPB and oligo-BCPAF as used in the preparation of the varnish A was placed. To the sulfonation product, 30 g of distilled water, 63 g of tetrahydrofuran (referred to as “THF” hereinafter) and 5 g of NMP were added, and they were stirred for 20 hours by a wave rotor to obtain a sulfonated polyarylene varnish (referred to as a “varnish C” hereinafter) having a viscosity of 58 mPa·s (25° C.).

### Preparation Example 4

### To Prepare Sulfonated Polyarylene Varnish

In a 250 ml plastic bottle, 2 g of the same sulfonation product of a copolymer of 2,5-DCPPB and oligo-BCPAF as used in the preparation of the varnish A was placed. To the sulfonation product, 40 g of distilled water, 53 g of methyl ethyl ketone (referred to as “MEK” hereinafter) and 5 g of NMP were added, and they were stirred for 20 hours by a wave rotor to obtain a sulfonated polyarylene varnish (referred to as a “varnish D” hereinafter) having a viscosity of 100 mPa·s (25° C.).

### Preparation Example 5

### To Prepare Sulfonated Polyarylene Varnish

In a 250 ml plastic bottle, 2 g of the same sulfonation product of a copolymer of 2,5-DCPPB and oligo-BCPAF as used in the preparation of the varnish A was placed. To the sulfonation product, 10 g of distilled water, 63 g of THF and 25 g of NMP were added, and they were stirred for 20 hours by a wave rotor to obtain a sulfonated polyarylene varnish (referred to as a “varnish E” hereinafter) having a viscosity of 70 mPa·s (25° C.).

### Preparation Example 6

### To Prepare Sulfonated Polyarylene Varnish

In a 250 ml plastic bottle, 4 g of a sulfonation product (trade name: Nafion 117, available from DuPont Co.) of a tetrafluoroethylene copolymer was placed. To the sulfonation product, 15 g of distilled water, 20 g of methanol, 40 g of isopropyl alcohol and 21 g of normal propyl alcohol were added, and they were stirred for 20 hours by a wave rotor to obtain a sulfonated polyarylene varnish (referred to as a “varnish F” hereinafter) having a viscosity of 90 mPa·s (25° C.).

### Preparation Example 7

### To Prepare Sulfonated Polyarylene Varnish

In a 250 ml plastic bottle, 10 g of the same sulfonation product of a copolymer of 2,5-DCPPB and oligo-BCPAF as used in the preparation of the varnish A was placed. To the sulfonation product, 20 g of distilled water, 50 g of THF and 20 g of NMP were added, and they were stirred for 20 hours by a wave rotor to obtain a sulfonated polyarylene varnish (referred to as a “varnish (a)” hereinafter) having a viscosity of 5,290 mPa·s (25° C.).

### Preparation Example 8

### To Prepare Sulfonated Polyarylene Varnish

In a 250 ml plastic bottle, 10 g of the same sulfonation product of a copolymer of 2,5-DCPPB and oligo-BCPAF as used in the preparation of the varnish A was placed. To the sulfonation product, 10 g of distilled water, 40 g of THF and 40 g of NMP were added, and they were stirred for 20 hours by a wave rotor to obtain a sulfonated polyarylene varnish (referred to as a “varnish (b)” hereinafter) having a viscosity of 5,400 mPa·s (25° C.).

### Preparation Example 9

### To Prepare Sulfonated Polyarylene Varnish

In a 250 ml plastic bottle, 10 g of the same sulfonation product of a copolymer of 2,5-DCPPB and oligo-BCPAF as used in the preparation of the varnish A was placed. To the sulfonation product, 90 g of NMP was added, and they were stirred for 20 hours by a wave rotor to obtain a sulfonated polyarylene varnish (referred to as a “varnish (c)” hereinafter) having a viscosity of 2,230 mPa·s (25° C.).

### Example 5

The varnish C was applied onto a catalyst layer of a 1 mg/cm² platinum-supported gas diffusion electrode (manufactured by U.S. Electrochem Inc.) by spray coating using a spray, and then dried under heating at 100° C. for 30 minutes to form a proton-conductive polymer thin film having a thickness of 0.8 μm.

Subsequently, the varnish (a) was applied onto the thin film by coater coating using a doctor blade, and then dried under heating at 100° C. for 1 hour to form a proton-conductive polymer film having a thickness of 40 μm. Thus, an electrolyte membrane-bonded electrode was prepared. Then, observation of the cross-section and measurement of the specific surface area of all pores were made in the aforesaid manner. The results are set forth in Table 2.

Further, preparation of a fuel cell and evaluation of performance thereof were carried out in the aforesaid manner. With regard to the power-generable time, change in voltage with time was observed, and a period of time taken until the voltage became 0 V was regarded as a power-generable time. The results are set forth in Table 2.

### Examples 6 and 7, Comparative Example 3

An electrolyte membrane-bonded electrode and a membrane-electrode assembly were prepared in the same 5 manner as in Example 5, except that varnishes shown in Table 2 were used instead of the varnish C and the varnish (a). Then, evaluation was carried out in the same manner as described above. The results are set forth in Table 2.

TABLE 2

| | | | | Specific | | |
|---|---|---|---|---|---|---|
| | | | Result of | surface | | Power- |
| | | | cross- | area of | Initial | generable |
| | Varnish | Varnish | section | all pores | voltage | time |
| | composition 3 | composition 4 | observation*3 | (m²/cm²) | (V) | (h) |
| Ex. 5 | C | (a) | AA | 5.58 | 0.58 | 582 |
| | (water 30%) | (water 20%) | | | | |
| Ex. 6 | C | (b) | AA | 5.70 | 0.58 | 693 |
| | (water 30%) | (water 10%) | | | | |
| Ex. 7 | D | (b) | AA | 5.69 | 0.59 | 740 |
| | (water 40%) | (water 10%) | | | | |
| Comp. | none | (c) | CC | 0.45 | — | — |
| Ex. 3 | | (water 0%) | | | | |

*3 AA: The degree of penetration of the solution into the electrode layer was less than 1 μm.
BB: The degree of penetration of the solution into the electrode layer was in the range of 1 to 3 μm.
CC: The degree of penetration of the solution into the electrode layer exceeded 3 μm.

### Example 8

In a 250 ml plastic bottle, 10 g of the same sulfonation product of a copolymer of 2,5-DCPPB and oligo-BCPAF as used in the preparation of the varnish A was placed. To the sulfonation product, 20 g of distilled water, 50 g of THF and 20 g of NMP were added, and they were stirred for 20 hours by a wave rotor to obtain a varnish composition having a viscosity of 5,290 mPa·s (25° C.)

Example 9

In a 250 ml plastic bottle, 10 g of the same sulfonation product of a copolymer of 2,5-DCPPB and oligo-BCPAF as used in the preparation of the varnish A was placed. To the sulfonation product, 10 g of distilled water, 40 g of THF and 40 g of NMP were added, and they were stirred for 20 hours by a wave rotor to obtain a varnish composition having a viscosity of 5,290 mPa·s (25° C.)

Example 10

In a 250 ml plastic bottle, 10 g of the same sulfonation product of a copolymer of 2,5-DCPPB and oligo-BCPAF as used in the preparation of the varnish A was placed. To the sulfonation product, 20 g of distilled water, 50 g of MEK and 20 g of NMP were added, and they were stirred for 20 hours by a wave rotor to obtain a varnish composition having a viscosity of 3,230 mPa·s (25° C.).

### Example 11

In a 250 ml plastic bottle, 10 g of the same sulfonation product of a copolymer of 2,5-DCPPB and oligo-BCPAF as used in the preparation of the varnish A was placed. To the sulfonation product, 15 g of distilled water, 55 g of dimethoxysilane (also referred to as “DME” hereinafter) and 20 g of NMP were added, and they were stirred for 20 hours by a wave rotor to obtain a varnish composition having a viscosity of 1,260 mPa·s (25° C.).

### Comparative Example 4

In a 250 ml plastic bottle, 15 g of the same sulfonation product of a copolymer of 2,5-DCPPB and oligo-BCPAF as used in the preparation of the varnish A was placed. To the sulfonation product, 42.5 g of methanol (also referred to as “MeOH” hereinafter) and 42.5 g of NMP were added, and they were stirred for 20 hours by a wave rotor to obtain a varnish composition having a viscosity of 1,980 mPa·s (25° C.).

### Comparative Example 5

In a 250 ml plastic bottle, 10 g of the same sulfonation product of a copolymer of 2,5-DCPPB and oligo-BCPAF as used in the preparation of the varnish A was placed. To the sulfonation product, 20 g of distilled water and 70 g of THF were added, and they were stirred for 20 hours by a wave rotor to obtain a varnish composition having a viscosity of 3,950 mPa·s (25° C.).

### Reference Example 1

In a 250 ml plastic bottle, 10 g of the same sulfonation product of a copolymer of 2,5-DCPPB and oligo-BCPAF as used in the preparation of the varnish A was placed. To the sulfonation product, 5 g of distilled water, 87 g of THF and 8 g of NMP were added, and they were stirred for 20 hours by a wave rotor to obtain a varnish composition having a viscosity of 6,830 mPa·s (25° C.).

### Evaluation 1

(Hot Water Resistance Test)

The varnish compositions obtained in Examples 8 to 11, Comparative Examples 4 and 5 and Reference Example 1 were each applied onto a PET film by means of a doctor blade. The varnish composition thus applied was dried in an oven at 70° C. for 30 minutes and then further dried in an oven at 150° C. for 60 minutes to obtain a sulfonated polyarylene film having a thickness of 40 to 60 μm.

The film prepared from each varnish composition was cut into a size of 2.0 cm×3.0 cm and weighed. The resulting film was used as a test piece. This film was placed in a 250 ml polycarbonate bottle, then about 100 ml of distilled water was added, and the bottle was heated at 120° C. for 24 hours using a pressure cooker tester (PC-242HS manufactured by HIRAYAMA MFS CORP.). After the test was completed, each film was taken out of the hot water, and water on the surfaces of the film was slightly wiped off with a Kimwipe. The weight of the test piece (film) containing water was measured to determine a water content. Further, the size of the film was measured to determine a degree of swelling. Then, the film was dried for 5 hours by a vacuum dryer to remove water. The weight of the film after the hot water test was measured to determine a weight residual ratio. The results are set forth in Table 3.

TABLE 3

| | | | | Weight |
|---|---|---|---|---|
| | Constituent of varnish | Water | Degree of | residual |
| | composition | content | swelling | ratio |
| | (weight ratio) | (%) | (%) | (%) |
| Ex. 8 | water/THF/NMP = 20/50/20 | 320 | 140 | 100 |
| Ex. 9 | water/THF/NMP = 10/40/40 | 280 | 140 | 100 |
| Ex. 10 | water/MEK/NMP = 20/50/20 | 290 | 142 | 98 |
| Ex. 11 | water/DME/NMP = 15/55/20 | 250 | 142 | 99 |
| Comp. | MeOH/NMP = 1/1 | 300 | 135 | 99 |
| Ex. 4 | | | | |
| Comp. | water/THF = 20/70 | 1,200 | 145 | 92 |
| Ex. 5 | | | | |
| Ref. | water/THF/NMP = 5/87/8 | 800 | 135 | 98 |
| Ex. 1 | | | | |

### Evaluation 2

(Fenton's Reagent Resistance Test)

The varnish compositions obtained in Examples 8 to 11, Comparative Examples 4 and 5 and Reference Example 1 were each applied onto a PET film by means of a doctor blade. The varnish composition thus applied was dried in an oven at 70° C. for 30 minutes and then further dried in an oven at 150° C. for 60 minutes to obtain a sulfonated polyarylene film having a thickness of 40 to 60 μm.

The film thus prepared was cut into a size of 3.0 cm×4.0 cm and weighed. The resulting film was used as a test piece. The test piece was immersed in 200 ml (per piece) of distilled water for 48 hours to elute the residual solvent from the film. In this process, distilled water was renewed twice. After the immersion in water, the film was sandwiched between filter papers to absorb water on the surfaces of the film, and then air-dried for one night, followed by weighing.

Separately, commercially available 30% hydrogen peroxide water was diluted with distilled water so as to give 3% hydrogen peroxide water. Then, ferrous sulfate heptahydrate was added so that the content of Fe(II) ion in the resulting solution became 20 ppm and was dissolved. Thus, a Fenton's reagent was prepared. In a 250 ml plastic bottle, 200 ml of this solution was poured and heated in a water bath to maintain the temperature constant at 45° C. After confirmation that the solution became 45° C., each film was placed in the solution and warmed for 26 hours. After warming for 26 hours, the solid was taken out of the solution and air-dried for one night. Then, the weight was measured to determine a weight residual ratio. The results are set forth in Table 4.

TABLE 4

| | Constituent of varnish | Weight residual ratio |
|---|---|---|
| | composition | after 26 hours |
| | (weight ratio) | (%) |
| Ex. 8 | water/THF/NMP = 20/50/20 | 92 |
| Ex. 9 | water/THF/NMP = 10/40/40 | 95 |
| Ex. 10 | water/MEK/NMP = 20/50/20 | 96 |
| Ex. 11 | water/DME/NMP = 15/55/20 | 93 |
| Comp. Ex. 4 | MeOH/NMP = 1/1 | 92 |
| Comp. Ex. 5 | water/THF = 20/70 | 0 |
| Ref. Ex. 1 | water/THF/NMP = 5/87/8 | 0 |

### Evaluation 3

(SEM Observation of Section After Application onto Electrode Layer)

The varnish compositions obtained in Examples 8 to 11, Comparative Examples 4 and 5 and Reference Example 1 were each applied onto a catalyst layer of a 1 mg/cm² platinum-supported gas diffusion electrode (manufactured by U.S. Electrochem Inc.) by means of a doctor blade. The varnish composition thus applied was dried in an oven at 70° C. for 30 minutes and then further dried in an oven at 150° C. for 60 minutes to form a sulfonated polyarylene film on the electrode layer. The thickness of the resulting film was adjusted to 40 to 60 μm.

The electrode layer bonded with the sulfonated polymer film was cut with a microtome to expose a cross-section, and the cross-section was smoothed. Then, the cross-section was observed by a scanning electron microscope (SEM) to examine a degree of penetration of the sulfonated polymer solution into the electrode layer. The results are set forth in Table 5.

TABLE 5

| | | Ability of inhibition of |
|---|---|---|
| | Constituent of varnish | solution penetration |
| | composition (weight ratio) | into electrode layer |
| Ex. 8 | water/THF/NMP = 20/50/20 | AA |
| Ex. 9 | water/THF/NMP = 10/40/40 | AA |
| Ex. 10 | water/MEK/NMP = 20/50/20 | AA |
| Ex. 11 | water/DME/NMP = 15/55/20 | AA |
| Comp. | NeOH/NMP = 1/1 | CC |
| Ex. 4 | | |
| Comp. | water/THF = 20/70 | CC |
| Ex. 5 | | |
| Ref. | water/THF/NMP = 5/87/8 | AA |
| Ex. 1 | | |

AA: The degree of penetration of the solution into the electrode layer was less than 1 μm.
BB: The degree of penetration of the solution into the electrode layer was in the range of 1 to 3 μm.
CC: The degree of penetration of the solution into the electrode layer exceeded 3 μm.

### Evaluation 4

(Evaluation of Power Generation Property)

Two gas diffusion electrodes having platinum catalyst supported thereon (1 mg/cm² platinum-supported gas diffusion electrode manufactured by U.S. Electrochem Inc.) were prepared. The varnish compositions obtained in Examples 8 to 11, Comparative Examples 4 and 5 and Reference Example 1 were each applied onto the gas diffusion electrode, and dried at ordinary temperature for 15 minutes. Then, the two electrodes were laminated in such a manner that the electrolyte varnish coating surfaces faced each other, to prepare a membrane-electrode assembly. Then, the membrane-electrode assembly thus prepared was sandwiched between two collectors made of titanium, and outside the collectors, heaters are arranged to constitute a fuel cell having an effective area of 0.25 cm².

The temperature of the fuel cell was maintained at 80° C. To the fuel electrode was fed hydrogen at a humidity of 35% RH and 2 atm, and to the oxidation electrode was fed oxygen at a humidity of 65% RH and 2 atm. When the current density was 1 A/cm², a terminal voltage was measured, and as a result, it was 0.60 V. Further, change of voltage with time was observed, and a period of time taken until the voltage became 0 V was measured as a power generable time. As a result, the power generable time was 1,051 hours.

The initial voltage and the power generable time of the membrane-electrode assemblies prepared by the use of the varnish compositions obtained in Examples 8 to 11, Comparative Examples 4 and 5 and Reference Example 1 are set forth in Table 6.

TABLE 6

| | | Power |
|---|---|---|
| | | generation |
| | Initial voltage | available time |
| | (V) | (h) |
| Ex. 8 | 0.60 | 1,051 |
| Ex. 9 | 0.57 | 1,280 |
| Ex. 10 | 0.59 | 820 |
| Ex. 11 | 0.58 | 879 |
| Comp. | 0.45 | 1,103 |
| Ex. 4 | | |
| Comp. | 0.60 | 387 |
| Ex. 5 | | |
| Ref. | 0.59 | 520 |
| Ex. 1 | | |

TABLE 7
(General results)

| | | | | Power | |
|---|---|---|---|---|---|
| | Hot water | Oxidation | Inhibition of | generation | General |
| | resistance | resistance | penetration | property | evaluation |
| Ex. 8 | AA | AA | AA | AA | AA |
| Ex. 9 | AA | AA | AA | AA | AA |
| Ex. 10 | AA | AA | AA | AA | AA |
| Ex. 11 | AA | AA | AA | AA | AA |
| Comp. | AA | AA | CC | BB | CC |
| Ex. 4 | | | | | |
| Comp. | CC | CC | CC | BB | CC |
| Ex. 5 | | | | | |
| Ref. | CC | CC | AA | AA | CC |
| Ex. 1 | | | | | |

AA: very good
BB: good
CC: bad

### Example 12

Two gas diffusion electrodes having platinum catalyst supported thereon (1 mg/cm² platinum-supported gas diffusion electrode manufactured by U.S. Electrochem Inc.) were prepared. The varnish composition obtained in Example 8 was applied onto each of the gas diffusion electrode and dried at ordinary temperature for 15 minutes. Then, the varnish composition prepared in Comparative Example 4 was applied onto the resulting film and dried at ordinary temperature for 15 minutes.

The two gas diffusion electrodes with varnish composition layers were laminated in such a manner that the electrolyte varnish coating surfaces faced each other, to prepare a membrane-electrode assembly. Then, the membrane-electrode assembly was sandwiched between two collectors made of titanium, and outside the collectors, heaters are arranged to constitute a fuel cell having an effective area of 25 cm².

### Reference Example 2

A fuel cell was constituted in the same manner as in Example 12, except that the varnish composition prepared in Comparative Example 4 was not used.

### Evaluation 5

The fuel cells obtained in Example 12 and Reference Example 2 were allowed to undergo power generation in the same manner as in Evaluation 4. The proportion of the fuel cells exhibiting excellent power generation property was regarded as a non-defective ratio. The results are set forth in Table 8.

TABLE 8

| | Constituent of varnish composition | Non-defective |
|---|---|---|
| | (weight ratio) | ratio (%) |
| Ex. 12 | water/THF/NMP = 20/50/20 + methanol/ | 99 |
| | NMP = 1/1 (two-layer coating) | |
| Ref. | water/THF/NMP = 20/50/20 (single-layer | 91 |
| Ex. 2 | coating) | |

### INDUSTRIAL APPLICABILITY

According to the process for producing an electrolyte membrane-bonded electrode of the invention, an electrolyte membrane can be formed on an electrode without penetration of the varnish into the electrode or repelling of the varnish by the electrode, and hence an electrolyte membrane-electrode bonded structure having excellent power generation property when constitutes an electrode assembly can be obtained.

The varnish composition 6 of the invention comprising a sulfonated polymer and a solvent can be uniformly applied onto the electrode without being repelled by the electrode, and hence a proton-conductive membrane having excellent power generation property can be formed.

What is claimed is:

1. A process for producing an electrolyte membrane-bonded electrode, comprising:
applying, onto an electrode, a water-containing dispersion which is obtained by dispersing a perfluorosulfonic acid polymer in a solvent containing an organic solvent A and water and has a perfluorosulfonic acid polymer content of 0.5 to 20% by weight, drying the dispersion to form a thin film 1 comprising the perfluorosulfonic acid polymer, then applying, onto the thin film 1, a solution of sulfonated polyarylene in an organic solvent B, and drying the solution to form a thin film 2 comprising the sulfonated polyarylene; and
thereby forming an electrolyte membrane comprising the thin film 1 and the thin film 2.

2. The process for producing an electrolyte membrane-bonded electrode as claimed in claim 1, wherein the water-containing dispersion of the perfluorosulfonic acid polymer is applied onto the electrode by spray coating.

3. A process for producing an electrolyte membrane-bonded electrode, comprising:
applying, onto an electrode, a proton-conductive polymer solution or dispersion which is obtained by dissolving or dispersing a proton-conductive polymer in a solvent containing an organic solvent B and water and has a water content of 25 to 50% by weight, drying the solution or dispersion to form a thin film 3 comprising the proton-conductive polymer, then applying, onto the thin film 3, a proton-conductive polymer solution or dispersion which is obtained by dissolving or dispersing a proton-conductive polymer in a solvent containing an organic solvent B and water and has a water content of less than 25% by weight, and drying the solution or dispersion to form a thin film 4 comprising the proton-conductive polymer; and
thereby forming an electrolyte membrane comprising the thin film 3 and the thin film 4.

4. The process for producing an electrolyte membrane-bonded electrode as claimed in claim 3, wherein the proton-conductive polymer is sulfonated polyarylene.

5. A process for producing an electrolyte membrane-bonded electrode, comprising:
applying, onto an electrode, a varnish composition 6 obtained by dissolving a sulfonated polymer in a solvent containing an organic solvent C, an organic solvent D and water, said organic solvent C being a good solvent for the sulfonated polymer and having a higher boiling point than that of other solvent components, said organic solvent D having a boiling point of not lower than 50° C. and being not a good solvent for the sulfonated polymer when used alone but causing a solubility region of the sulfonated polymer to appear when mixed with the organic solvent C and/or the water, and
drying the varnish composition 6 to form an electrolyte membrane comprising the sulfonated polymer.

6. The process for producing an electrolyte membrane-bonded electrode as claimed in claim 5, wherein the organic solvent C is a non-protonic dipole solvent having a dielectric constant of not less than 20.

7. The process for producing an electrolyte membrane-bonded electrode as claimed in claim 5, wherein the organic solvent D is selected from an alcohol, an ether and a ketone and has a solubility parameter of 7 to 14.5 (cal/mol)^{1/2}.

8. The process for producing an electrolyte membrane-bonded electrode as claimed in claim 5, wherein the organic solvent D is at least one solvent selected from ethanol, 1-propanol, 2-propanol, tetrahydrofuran, 1,3-dioxolan, dimethoxyethane, acetone, methyl ethyl ketone and cyclohexanone.

9. The process for producing an electrolyte membrane-bonded electrode as claimed in claim 5, wherein the weight ratio among the organic solvent C, the organic solvent D and water used is in the range of 20-85:10-75:5-70, with the proviso that the total is 100.

10. The process for producing an electrolyte membrane-bonded electrode as claimed in claim 5, wherein the sulfonated polymer is a non-perfluorohydrocarbonic sulfonated polymer or a sulfonated polymer having a polyarylene structure in its main chain.

11. A process for producing an electrolyte membrane-bonded electrode, comprising:
applying, onto an electrode, a varnish composition 6 obtained by dissolving a sulfonated polymer in a solvent containing an organic solvent C, an organic solvent D and water, said organic solvent C being a good solvent for the sulfonated polymer and having a higher boiling point than that of other solvent components, said organic solvent D having a boiling point of not lower than 50° C. and being not a good solvent for the sulfonated polymer when used alone but causing a solubility region of the sulfonated polymer to appear when mixed with the organic solvent C and/or the water,
drying the varnish composition 6 to form a thin film 6 comprising the sulfonated polymer,
then applying, onto the thin film 6, a varnish composition 7 obtained by dissolving a sulfonated polymer in a solvent consisting essentially of an alcohol having a boiling point of not higher than 100° C. and an organic solvent E having a boiling point of higher than 100° C., and
drying the varnish composition 7 to form a thin film 7; and
thereby forming an electrolyte membrane comprising the thin film 6 and thin film 7.

12. The process for producing an electrolyte membrane-bonded electrode as claimed in claim 11, wherein the alcohol for constituting the varnish composition 7 is methanol, ethanol, propanol or isopropyl alcohol.

13. The process for producing an electrolyte membrane-bonded electrode as claimed in claim 11, wherein the organic solvent E for constituting the varnish composition 7 is at least one solvent selected from N-methyl-2-pyrrolidone, N, N-dimethylformamide, N,N-dimethylacetamide, γ-butyrolactone, tetramethylurea, dimethyl sulfoxide, hexamethylphosphoric amide and sulfolane.

14. The process for producing an electrolyte membrane-bonded electrode as claimed in claim 11, wherein the weight ratio between the alcohol and the organic solvent E used for constituting the varnish composition 7 is in the range of 5-75:95-25, with the proviso that the total is 100.

15. A varnish composition obtained by dissolving a sulfonated polymer in a solvent containing an organic solvent C, an organic solvent D and water, wherein:
the organic solvent C is a good solvent for the sulfonated polymer and has a higher boiling point than that of other solvent components, and
the organic solvent D has a boiling point of not lower than 50° C. and is not a good solvent for the sulfonated polymer when used alone but causes a solubility region of the sulfonated polymer to appear when mixed with the organic solvent C and/or the water.

16. The varnish composition as claimed in claim 15, wherein the organic solvent C is a non-protonic dipole solvent having a dielectric constant of not less than 20.

17. The varnish composition as claimed in claim 15, wherein the organic solvent D is selected from an alcohol, an ether and a ketone and has a solubility parameter of 7 to 14.5 (cal/mol)^{1/2}.

18. The varnish composition as claimed in claim 15, wherein the organic solvent D is at least one solvent selected from ethanol, 1-propanol, 2-propanol, tetrahydrofuran, 1,3-dioxolan, dimethoxyethane, acetone, methyl ethyl ketone and cyclohexanone.

19. The varnish composition as claimed in claim 15, wherein the weight ratio among the organic solvent C, the organic solvent D and water used is in the range of 20-85:10-75:5-70, with the proviso that the total is 100.

20. The varnish composition as claimed in claim 15, wherein the sulfonated polymer is a non-perfluorohydrocarbonic sulfonated polymer or a sulfonated polymer having a polyarylene structure in its main chain.

21. The varnish composition as claimed in claim 15, which is a varnish composition for forming a proton-conductive membrane.
